(19) United States
(12) Patent Application Publication
(10) Pub. No.: US 2025/0390481 A1
(43) Pub. Date: Dec. 25, 2025

(54) UNIFIED DATA STRUCTURES FOR SOURCE-SPECIFIC DATA STRUCTURES ORIGINATING FROM THIRD-PARTY SOURCES

(71) Applicant: Dropbox, Inc., San Francisco, CA (US)

(72) Inventors: Steven Cox, Benicia, CA (US); Hiten Shah, Redwood City, CA (US); Marie Prokopets, San Jose, CA (US)

(21) Appl. No.: 18/886,697

(22) Filed: Sep. 16, 2024

Related U.S. Application Data
(60) Provisional application No. 63/663,351, filed on Jun. 24, 2024.

(51) Int. Cl. G06F 16/22

(52) U.S. Cl. CPC G06F 16/2272

(57) ABSTRACT

The present disclosure is directed toward systems, methods, and non-transitory computer-readable media for generating unified data items from source-specific data items originating from third-party sources. For example, the disclosed systems receive a plurality of source-specific data items from a first third-party source and a second third-party source. For instance, the source-specific data items include data that represents digital activity of multiple client devices using the third-party sources. Further, the disclosed systems generate a plurality of unified data items from the source-specific data items by using a translation layer that maps source-specific data structures to a unified data structure. Moreover, the disclosed systems identify a subset of unified data items based on a request from an administrator device and further provides the subset of unified data items to the administrator device.

### CROSS-REFERENCE TO RELATED APPLICATIONS

This application claims priority to and the benefit of U.S. Provisional Patent Application No. 63/663,351, filed on Jun. 24, 2024, which is incorporated herein by reference in its entirety.

### BACKGROUND

Advancements in computing devices and networking technology have given rise to a variety of innovations in creating secure network environments for various computing devices interacting over a computer network. Over time, computing systems have been developed that monitor actions from computing devices. For instance, some existing computing systems can detect malicious activities by running a forensic scan to ascertain forbidden actions taken by one or more computing devices. Despite these advances, however, existing computing systems continue to suffer from a number of disadvantages, particularly in terms of security, efficiency, accuracy, and flexibility.

As just mentioned, some existing computing systems are insecure. While certain existing computing systems can detect malicious activities by running a forensic scan on a computing systems, existing computing systems suffer from being reactive to malicious activity and not proactively preventing malicious activity from occurring in the first place. Specifically, existing computing systems often struggle to detect malicious activity within a reasonable amount of time and requires a skilled forensic analysis of all the actions taken on the computer system. As such, existing computing systems typically require multiple security breaches to occur before malicious behavior is detected. For example, some existing computing systems do not discover a security breach until months after an employee has left or after significant damage has been done.

For one, existing computing systems do not have a feasible method for monitoring interactions between client devices and third-party applications as it occurs, and existing computing systems typically analyze behavior “post-mortem.” Secondly, existing computing systems do not have an efficient method of interpreting/translating detected behavior into an indication of a security breach. Thus, these issues in part result in a snow-balling effect for the security of existing computing systems.

As just mentioned, existing computing systems lack efficient methods of monitoring and interpreting/translating detected behavior into an indication of a security breach. Specifically, existing computing systems typically work with multiple third-party applications. For example, multiple third-party applications often use different naming conventions to indicate the same type of actions. Because of this, existing computing systems are receiving thousands or hundreds of thousands of monitored interactions with different ways of expressing the same type of actions. As such, existing computing systems often fail to parse through the thousands of monitored interactions and fail to efficiently interpret actions across different data source applications. Thus, existing computing systems often fail to establish an efficient method of detecting when a received action constitutes a security breach. To do so, existing computing systems would need to perform an in-depth forensic analysis (post-mortem) of the thousands or hundreds of thousands of monitored interactions.

Furthermore, querying existing computing systems to attempt to identify illicit behavior is often extremely time consuming due to the paginated nature of third-party applications that integrate with existing computing systems. In other words, existing computing systems often require loading and reloading data for the third-party applications over and over again. Moreover, querying in existing computing systems are also very limited in the amount of information available, thus search results often are not helpful or contain such generic information that it is essentially useless. These problems further exacerbate efficiency issues of existing computing systems.

In addition to their insecurity and inefficiency issues, existing computing systems are also inaccurate. More particularly, as just mentioned, third-party applications often use different naming conventions to indicate the same type of actions. As a result, existing computing systems struggle to identify whether a monitored interaction from one third-party application is the same or different from another third-party application. Moreover, third-party applications differ in the level of detail they provide to existing computing systems. At times, third-party applications provide very bare or generic descriptions of the monitored interactions. Thus, existing computing systems can incorrectly or inaccurately identify a monitored interaction as prohibited when in reality the data source application failed to provide a sufficient level of detail to make a correct determination.

Relatedly, existing computing systems further suffer from operational inflexibility. Because existing computing systems struggle to parse and interpret thousands of monitored interactions coming from multiple third-party applications, existing computing systems further fail to adapt to additional third-party applications that integrate with the existing computing systems. In other words, the existing computing systems fail to flexibly scale up to a larger volume of monitored interactions and third-party applications.

### SUMMARY

This disclosure describes one or more embodiments of systems, methods, and non-transitory computer-readable storage media that provide benefits and/or solve one or more of the foregoing and other problems in the art. For instance, the disclosed systems receive a plurality of source-specific data items from various third-party sources. Specifically, the source-specific data items represent digital activity of a plurality of client devices using the various third-party sources. In some cases, the disclosed systems generate a plurality of unified data items from the plurality of source-specific data items by using a translation layer that maps source-specific data structures to a unified data structure. For example, the disclosed systems receive a request from an administrator device and identifies a subset of unified data items from the plurality of unified data items. In particular, the disclosed systems process the request using the unified data structure and the identified subset of unified data items is based on the source-specific data items from multiple third-party sources.

### BRIEF DESCRIPTION OF THE DRAWINGS

This disclosure will describe one or more example implementations of the systems and methods with additional specificity and detail by referencing the accompanying figures. The following paragraphs briefly describe those figures, in which:

FIG. 1 illustrates a schematic diagram of an example environment of a unified digital activity system in accordance with one or more embodiments;

FIG. 2 illustrates an example overview of the unified digital activity system providing a subset of unified data items to an administrator device in accordance with one or more embodiments;

FIG. 3 illustrates an example diagram of the unified digital activity system mapping source-specific data items to generate unified data items in accordance with one or more embodiments;

FIG. 4 illustrates an example diagram of the unified digital activity system mapping a specific source-specific data item to a unified data item in accordance with one or more embodiments;

FIG. 5 illustrates an example diagram of the unified digital activity system generating policies and determining a violation of a policy in accordance with one or more embodiments;

FIGS. 6A-6B illustrates an example diagram of the unified digital activity system detecting a violation of a policy and performing one or more acts in response to the violation in accordance with one or more embodiments;

FIGS. 7A-7H illustrates example graphical user interfaces of the unified digital activity system in accordance with one or more embodiments;

FIG. 8 illustrates an example series of acts performed by the unified digital activity system in accordance with one or more embodiments;

FIG. 9 illustrates a block diagram of an exemplary computing device in accordance with one or more embodiments; and

FIG. 10 illustrates an example environment of a networking system having the unified digital activity system in accordance with one or more embodiments.

### DETAILED DESCRIPTION

This disclosure describes one or more embodiments of a unified digital activity system that can generate a plurality of unified data items from a plurality of source-specific data items originating from multiple third-party sources. Specifically, the unified digital activity system integrates with multiple third-party sources to transform audited data (e.g., source-specific data items) into a unified data structure. For example, the unified digital activity system can monitor data originating from third-party sources to determine when a content item is copied, downloaded, viewed, shared, or made into a public link (e.g., to detect security breaches or other types of prohibited actions). For instance, the unified digital activity system can monitor the activity logs of multiple third-party systems (e.g., content file storage applications, calendar applications, email applications, digital illustration applications, etc.) and use a translation layer to generate a unified data structure of all the monitored activity. In other words, the unified digital activity system uses the translation layer to make naming conventions across different third-party applications compatible (e.g., unified) and further makes the monitored activity intelligible/comprehensible to Internet technology professionals (a.k.a., IT professionals) and administrators (e.g., the generated unified data items can provide a sufficient level of detail for an administrator to determine a security breach and what specific content items/client devices were involved in the security breach).

Moreover, after translating the monitored activity from the multiple third-party applications, the unified digital activity system can receive a query from an administrator device and provide a subset of the translated activity data (e.g., the unified data items, and in some embodiments, an interpretation of the unified data items) from the multiple third-party sources to the administrator device. Thus, the unified digital activity system enables computing devices (e.g., IT professionals and administrators) to view and manage audited activity within a streamlined interface.

In one or more embodiments, the unified digital activity system creates the translation layer to efficiently and accurately translate between source-specific data structures to a unified data structure. Specifically, the unified digital activity system can map a first third-party source to the translation layer and a second third-party source to the translation layer. For example, the unified digital activity system can use a generated specification (e.g., a reference manual) to process source-specific data items and extract the correct level of detail (e.g., the unified digital activity system can provide more granular detail when necessary and more abstract details when the information is too specific/uninformative), which is translated to be compatible with the unified data structure. For instance, in some embodiments, the unified digital activity system uses engineering efforts to inspect one or more third-party sources and create the mapping between the one or more third-party sources and the unified data structure. In some embodiments however, the unified digital activity system can use machine learning to map data from a specific third-party system to the translation layer.

As alluded to above, the unified digital activity system can also provide the capability to manage customer implemented policies across multiple third-party applications. The unified digital activity system allows users (e.g., IT professionals and administrators) to indicate policies within an interface. After indicating the policies, the unified digital activity system interprets the monitored activity and determines when one or more policies are violated. In response to this determination, the unified digital activity system can automatically enforce the policy. In some instances, the unified digital activity system can further send a notification to a user who violates a policy and further sends a notification to the administrator.

Moreover, the unified digital activity system also adds flexibility to the policy-enforcing aspect. In one or more embodiments a user of a client device can violate an established policy, and the unified digital activity system can send a notification message to an administrator device where the notification contains an exception to the violated policy. Specifically, the administrator device can deny or grant the exception to the client device violating the policy. In response to denying the exception, the unified digital activity system can continue with enforcing the policy. In response to granting the exception, the unified digital activity system can allow the violation to persist.

In one or more embodiments, the unified digital activity system can further establish various efficiency mechanisms. Specifically, the unified digital activity system can use a thresholding policy to minimize repetitive notifications sent to administrator devices. Moreover, the unified digital activity system can use machine learning to summarize translated activity in response to an administrator request (e.g., rather than just providing the subset of unified data items, the unified digital activity system can also provide an interpretation of the subset of unified data items). Further, the unified digital activity system can further generate data analytic reports to determine proper resource usage (e.g., how many users are using a specific software application with respect to number of licensed seats).

As suggested above, the unified digital activity system can provide several improvements or advantages over existing systems. For instance, in some embodiments, the unified digital activity system improves data security relative to prior systems. As mentioned above, existing computing systems struggle with detecting malicious activity within a reasonable amount of time and requires a “post-mortem” forensic analysis of all the actions taken on the computer system. Thus, resulting in security breaches that can persist for months or after significant damage has already been done. In contrast, the unified digital activity system can translate the plurality of source-specific data items (e.g., originating from multiple third-party sources) to the unified data structure to generate the unified data items. Moreover, the unified data items contain a level of detail and comprehensibility sufficient to detect security breaches. Specifically, the unified digital activity system can provide a subset of unified data items to an administrator device (e.g., in response to a request from an administrator device). Furthermore, the unified digital activity system can automatically enforce (e.g., unlike existing computing systems which are limited to post-mortem enforcement) one or more digital security policies in response to detecting one or more unified data items that indicate a violation of the one or more digital security policies.

In addition to improving upon security, the unified digital activity system also improves upon efficiency as compared to prior systems. As mentioned above, existing computing systems lack efficient methods of monitoring and translating detected behavior into an indication of a security breach and further struggle to parse through and interpret thousands or hundreds of thousands of monitored interactions. In contrast, the unified digital activity system proactively ingests monitored activity (e.g., the source-specific data items originating from multiple third-party sources) and generates a plurality of unified data items from the source-specific data items. In particular, the unified digital activity system uses a translation layer to transform the source-specific data into an intelligible and comprehensible data item that contains a level of detail sufficient to determine who committed a security breach and what content items were involved in the security breach. In other words, the unified digital activity system pulls together all the monitored activity from all the third-party sources into a single unified data structure and increases the efficiency of detecting security breaches (e.g., by monitoring the unified data items).

Moreover, as mentioned above, the unified digital activity system can manage and enforce customer-implemented digital security policies. As mentioned above, conventional systems typically struggle with only reactively responding to security breaches and sometimes only detecting security breaches post-mortem (e.g., after performing an in-depth forensic analysis, which can take a lot of time and resources). In contrast, the unified digital activity system establishes digital security policies and monitors the unified data items to determine when one or more of the digital security policies are violated. In response to a determination that a digital security policy is violated, the unified digital activity system can reverse the action (e.g., enforce the policy).

Furthermore, in some embodiments the unified digital activity system improves accuracy relative to prior systems. As mentioned above, conventional systems typically struggle to identify whether a monitored interaction constitutes a prohibited action due to the variance of data and naming conventions originating from different third-party applications. In contrast, the unified digital activity system maps source-specific data structures of various third-party applications to the unified data structure. In doing so, the unified digital activity system generates the unified data items from the source-specific data items that contain a level of detail sufficient to detect security breaches (e.g., a level of detail that is comprehensible/informative to an administrator device). As such, the unified digital activity system can accurately determine when one or more monitored activities rises to the level of violating a digital security policy.

Due at least in part to improving security, efficiency, and accuracy, the unified digital activity system also improves upon operational flexibility. As mentioned above, conventional systems are rigidly limited to forensic analyses after security breaches and managing a smaller number of monitored interactions between client devices and third-party applications. In contrast, the unified digital activity system proactively transforms source-specific data items into unified data items and can proactively monitor interactions and enforce digital security policies. Moreover, the unified digital activity system can scale up to a large volume (e.g., hundreds of thousands) of monitored interactions and integrations with multiple third-party application sources without suffering from accuracy concerns (e.g., the unified data items contain a comprehensible/informative level of detail that is provided to one or more administrator devices). Thus, the unified digital activity system more flexibly adjusts to a large volume of monitored interactions and more flexibly addresses security concerns in a proactive manner (e.g., relative to existing computing systems).

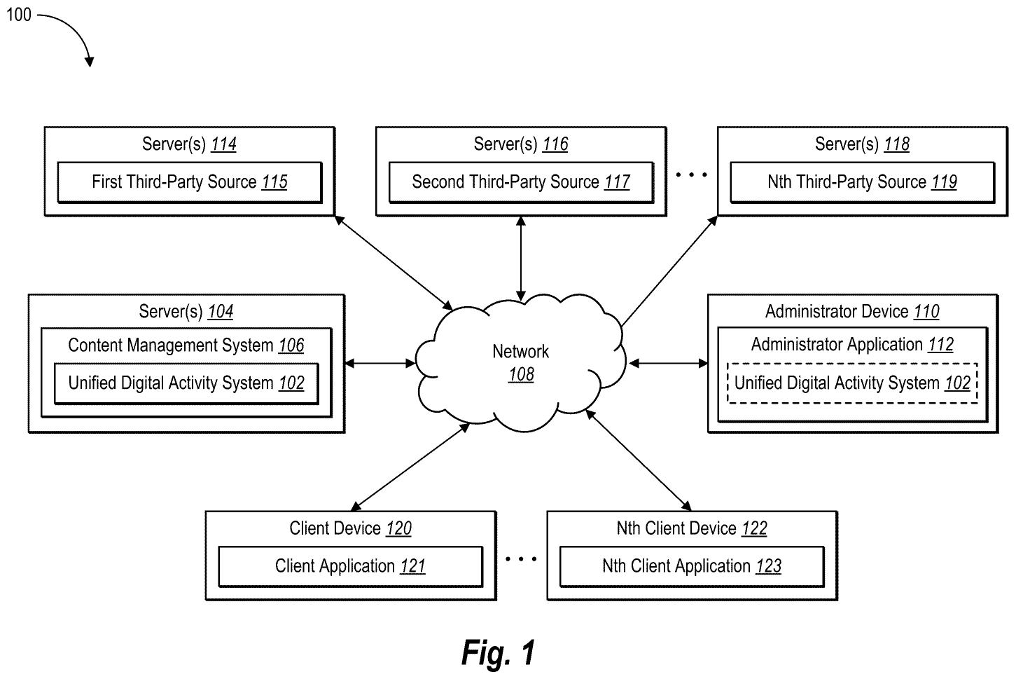

Additional detail regarding the unified digital activity system will now be provided with reference to the figures. For example, FIG. 1 illustrates a schematic diagram of an example system environment for implementing a unified digital activity system 102 in accordance with one or more implementations. An overview of the unified digital activity system 102 is described in relation to FIG. 1. Thereafter, a more detailed description of the components and processes of the unified digital activity system 102 is provided in relation to the subsequent figures.

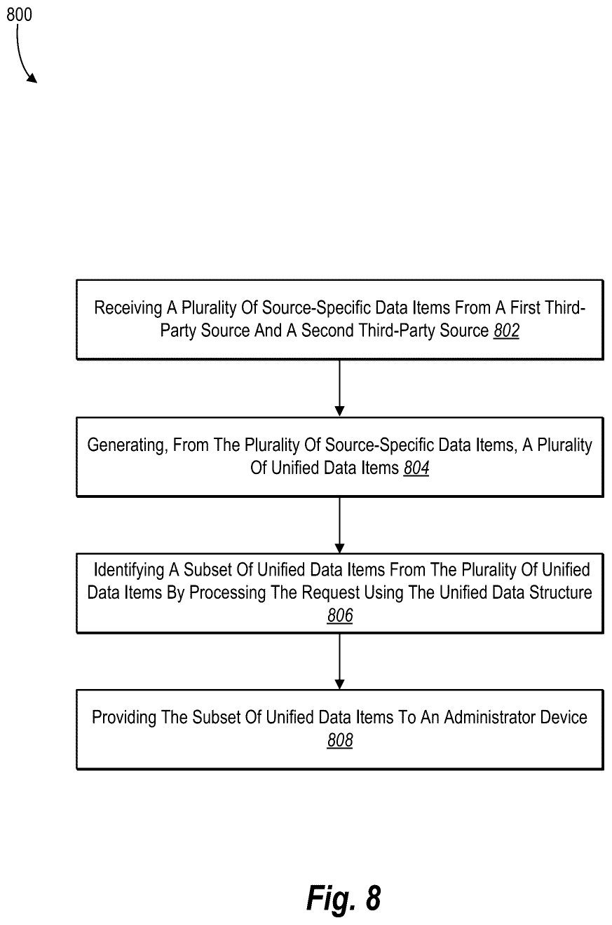

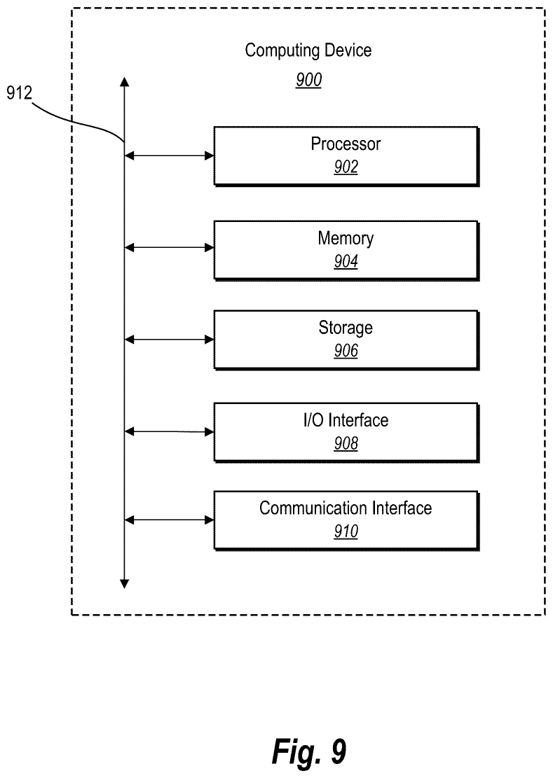

As shown, the environment 100 includes server(s) 104 with the unified digital activity system 102, server(s) 114 that include a first third-party source 115, server(s) 116 that include a second third-party source 117, and server(s) 118 that include an Nth third-party source 119. Further the environment 100 includes an administrator device 110, client device 120 and an Nth client device 122. Each of the components of the environment can communicate via a network 108, and the network 108 may be any suitable network over which computing devices can communicate. Example networks are discussed in more detail below in relation to FIGS. 8-9.

As mentioned above, the example environment includes the administrator device 110 and the client device 120 and the Nth client device 122. The aforementioned devices can be one of a variety of computing devices, including a smartphone, a tablet, a smart television, a desktop computer, a laptop computer, a virtual reality device, an augmented reality device, or another computing device as described in relation to FIGS. 8-9. The aforementioned devices can communicate with the server(s) 104 via the network 108.

For example, the client device 120 and the Nth client device 122 can receive user input from a user interacting with the device (e.g., via a client application 121 and an Nth client application 123) to, for instance, interact with (e.g., copy, download, transmit, create, etc.) the first third-party source 115, the second third-party source 117, and/or the Nth third-party source 119. In addition, the unified digital activity system 102 on the server(s) 104 can receive information relating to various interactions with content items and/or user interface elements based on the input received by the client device 120 and the Nth client device 122.

As shown, the client device 120 and the Nth client device 122 can include the client application 121 and the Nth client application 123. In particular, the client applications may be a web application, a native application installed on the client devices (e.g., a mobile application, a desktop application, etc.), or a cloud-based application where all or part of the functionality is performed by the server(s) 104. Based on instructions from the client applications, the client devices can present or display information, including a user interface for interacting with (or collaborating regarding) generating/modifying/accessing content items located on one or more of the third-party sources. Using the client applications, the client devices can perform (or request to perform) various operations.

In addition to the client devices, the administrator device 110 can also receive user input via an administrator application 112. Specifically, a user of the administrator device 110 can interact with the administrator application 112 to perform one or more operations. For example, the administrator device 110 can send a request to obtain a subset of unified data items based on monitoring the server(s) 114, the server(s) 116, and the server(s) 118. Moreover, the administrator device 110 can receive the subset of unified data items from the unified digital activity system 102. Additionally, the administrator device 110 can generate digital policies for the unified digital activity system 102 to enforce and can further approve exceptions to policy violations. Although FIG. 1 shows the administrator device 110, in one or more embodiments, the environment 100 can include a plurality of administrator devices. For instance, each of the plurality of administrator devices can be assigned to monitor various policies for different third-party sources.

As illustrated in FIG. 1, the example environment also includes the server(s) 104. The server(s) 104 may receive source-specific data items from the server(s) 114, the server(s) 116, and the server(s) 118; generate unified data items from the source-specific data items; identify a subset of unified data items in response to a request from the administrator device 110; and provide the identified subset of unified data items to the administrator device 110. For example, the server(s) 104 may receive an indication from the client device 120 and/or the Nth client device 122 interacting with one or more of the third-party sources and can further translate the monitored interactions into unified data items. In addition, the server(s) 104 can transmit data to the client device 120 and the Nth client device 122 in the form of a notification indicating the client devices have violated one or more digital policies. Moreover, the server(s) 104 can communicate with the administrator device 110 to send and/or receive data via the network 108. In some implementations, the server(s) 104 comprise(s) a distributed server where the server(s) 104 include(s) a number of server devices distributed across the network 108 and located in different physical locations. The server(s) 104 can comprise one or more content servers, application servers, container orchestration servers, communication servers, web-hosting servers, machine learning server, and other types of servers.

As shown in FIG. 1, the server(s) 104 can also include the unified digital activity system 102 as part of a content management system 106. The content management system 106 can communicate with the client device 120 and the Nth client device 122 to perform various functions associated with the client application 121 and the Nth client application 123 such as managing user accounts, storing and synchronizing content items, and facilitating collaboration among user accounts. Indeed, the content management system 106 can include a network-based smart cloud storage system to manage, store, and maintain content items and related data across numerous user accounts. In some embodiments, the unified digital activity system 102 and/or the content management system 106 utilize a database to store and access information such as content items, source-specific data items originating from third-party applications, and unified data items.

Although FIG. 1 depicts the unified digital activity system 102 located on the server(s) 104, in some implementations, the unified digital activity system 102 may be implemented by (e.g., located entirely or in part on) one or more other components of the environment. For example, the unified digital activity system 102 may be implemented by the administrator device 110 and/or a third-party system. For example, the administrator device 110 and/or a third-party system can download all or part of the unified digital activity system 102 for implementation independent of, or together with, the server(s) 104.

In some implementations, though not illustrated in FIG. 1, the environment may have a different arrangement of components and/or may have a different number or set of components altogether. For example, the administrator device 110 may communicate directly with the unified digital activity system 102, bypassing the network 108. In addition, the environment can include a database located external to the server(s) 104 (e.g., in communication via the network 108) or located on the server(s) 104 and/or on the administrator device 110.

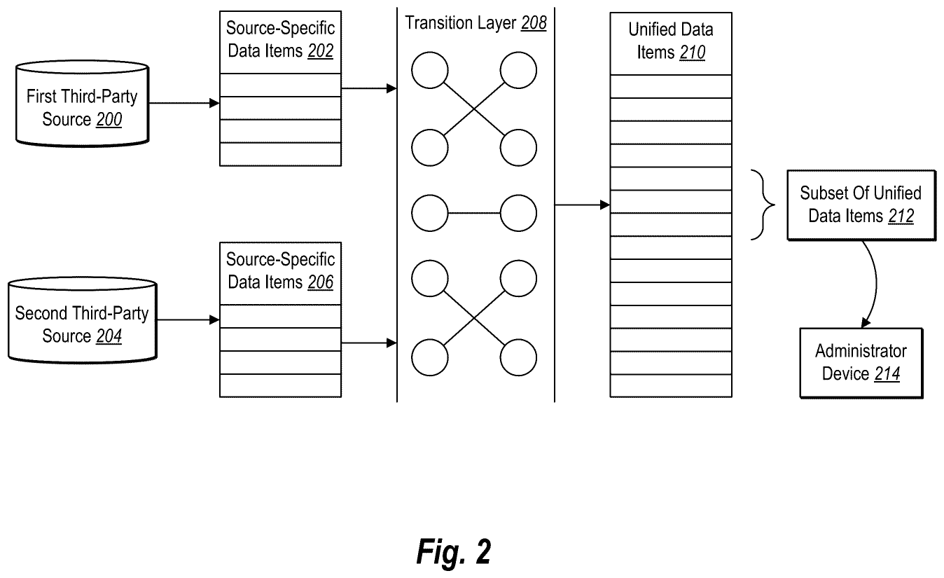

As mentioned above, the unified digital activity system 102 processes source-specific data items originating from third-party sources and generates unified data items. In other words, the unified digital activity system 102 creates a unified data structure for identifying a subset of unified data items that can indicate security breaches or violations of digital policies. FIG. 2 illustrates the unified digital activity system 102 sending a subset of unified data items to an administrator device in accordance with one or more embodiments.

As shown in FIG. 2, the unified digital activity system 102 receives source-specific data items 202 from a first third-party source 200 and source-specific data items 206 from a second third-party source 204. As used herein, the term “third-party source” refers to a software program or application created by an external entity. In other words, the third-party source refers to a software application source not generated or part of the content management system 106. Specifically, the third-party source can integrate with and function within the content management system 106. For example, the third-party source can offer additional features, functionalities, or services such as email applications, messaging applications, calendar applications, digital illustration applications, and additional document creation applications.

As used herein, the term “first third-party source” refers to a third-party source distinct from a “second third-party source.” Specifically, a first third-party source 200 can perform features, functions, or services different than a second third-party source 204. In one or more embodiments, the first third-party source 200 has naming conventions and tracked data distinct from the second third-party source 204. In other words, the first third-party source 200 tracks a specific set of data of client devices that differs from a specific set of data tracked by the second third-party source 204. Moreover, in some embodiments, the first third-party source 200 and the second third-party source 204 can track the same type of data but label the tracked data differently. For instance, the different third-party sources can have different levels of detail for the same type of tracked data (e.g., the level of granularity for a specific digital activity (such as copying a document) can vary for how a third-party source tracks that data and provides it to the unified digital activity system 102).

In one or more embodiments, the content management system 106 contains a plurality of client devices which also interact with the first third-party source 200 and the second third-party source 204 (e.g., the first third-party source 200 and the second third-party source 204 are integrated with the content management system 106). Furthermore, the unified digital activity system 102 can receive/monitor the data from the interactions between the client devices and the first third-party source 200 and the second third-party source 204.

Moreover, as mentioned above, the unified digital activity system 102 receives the source-specific data items 202 and the source-specific data items 206 from the third-party sources. As used herein, the term “source-specific data items” refers to extracted/received digital activity specific to a third-party source. In other words, the first third-party source 200 has source-specific data items based on the digital activity between the client devices and the first third-party source 200. For instance, the source-specific data items 202 and 206 refer to data packets or meta-data that result from an interaction between a client device and the first third-party source 200 and/or the second third-party source 204. Moreover, the second third-party source 204 has source-specific data items based on the digital activity between the client devices and the second third-party source 204. For example, each third-party source has a unique way of tracking digital activity/extracting information from data packets/meta-data (e.g., from a client device interacting with a third-party source), thus the manner in which digital activity is expressed for a third-party source is source specific.

Additionally, FIG. 2 shows the unified digital activity system 102 processing the source-specific data items 202 and the source-specific data items 206 at a translation layer 208. As used herein, the term “translation layer” refers to an architectural layer of the unified digital activity system 102. Specifically, the unified digital activity system 102 utilizes a translation layer 208 to transform or translate source specific data items (e.g., from third-party sources) to unified data items. As mentioned above, each third-party source can have different naming conventions and levels of details at which they track digital activity. As such, the unified digital activity system 102 utilizes the translation layer 208 to pull all the digital activity from multiple third-party sources together in a comprehensible and unified manner. In other words, the unified digital activity system 102 utilizes the translation layer 208 to translate source specific data items (e.g., by extracting details from the data packets and meta-data) to a level of detail and level of human comprehensibility needed by administrator devices.

As further shown in FIG. 2, the unified digital activity system 102 generates unified data items 210 from the source-specific data items 202 and the source-specific data items 206. As used herein, the term “unified data items” refers to the processed, transformed, and translated source-specific data items via the translation layer 208. Specifically, a source-specific data item can merely read “permissions,” but the source-specific data item further contains data packets, metadata, or information that indicates a timestamp, a client device, a type of permission, additional client devices involved with the permissions, and a specific document identifier. For example, the unified digital activity system 102 utilizes the translation layer 208 to translate “permissions” into a unified data item that reads “[user A] changed the editing permissions for [user B] to viewing permissions for [document Z] on Jun. 19, 2024 at 12:00 p.m.” Furthermore, in some embodiments, source-specific data items may read “access changed” (e.g., access changed correspond with “permissions”) and originates from a different third-party source. In such instances, the unified digital activity system 102 also generates a unified data item in the same manner as just discussed (e.g., “[user F] changed the editing permissions for [user D] to viewing permissions for [document X] on Jun. 15, 2024 at 11:00 p.m.”

FIG. 2 further shows the unified digital activity system 102 identifying a subset of unified data items 212. As also shown, the unified digital activity system 102 can provide the subset of unified data items 212 to an administrator device 214. As used herein, the term “administrator device” refers to system administrator, an information technology professional, or a network administrator that manages, monitors, and maintains the unified digital activity system 102. Specifically, the administrator device 214 can have full access and authentication permissions to pull the unified data items 210, send queries (e.g., regarding specific client device interactions with third-party sources or regarding which client devices performed specific types of digital activity), create policies, approve exceptions to policies, and deny exceptions to policies.

As mentioned above, the unified digital activity system 102 can receive a request from the administrator device 214 to provide the subset of unified data items 212. Specifically, the unified digital activity system 102 can receive a request from the administrator device 214 to pull the subset of unified data items 212 that relate to a specific client device and specific types of digital activity. In response, the unified digital activity system 102 can identify the subset of unified data items 212 of the unified data items that relate to the requested specific client device and the specific types of digital activity.

As used herein, the term “request” refers to a query or a prompt sent from the administrator device 214 to the unified digital activity system 102. Specifically, the request typically includes a query of one or more client devices and one or more types of digital activity. In other words, the unified digital activity system 102 receives a request to provide a subset of unified data items and an interpretation of the subset of the unified data items to the administrator device 214.

As used herein, the term “type of digital activity” refers to a category of interactions between client devices and third-party sources. Specifically, a type of digital activity can refer to changing permissions, duplicating a document, deleting a document, creating a public link, accessing a certain domain website, etc. (e.g., any type of digital activity between a client device and a third-party source). Moreover, the unified digital activity system 102 can receive a request from an administrator device with the specified type of digital activity (e.g., a query to determine which devices have performed a specific type of digital activity).

Although FIG. 2 shows the first third-party source 200 and the second third-party source, in one or more embodiments, the unified digital activity system 102 can process source-specific data items from a plurality of additional third-party sources. For instance, the unified digital activity system 102 can process source-specific data items from a third third-party source, a fourth third-party source, and a fifth third-party source. Specifically, the additional third-party sources are integrated with the content management system 106.

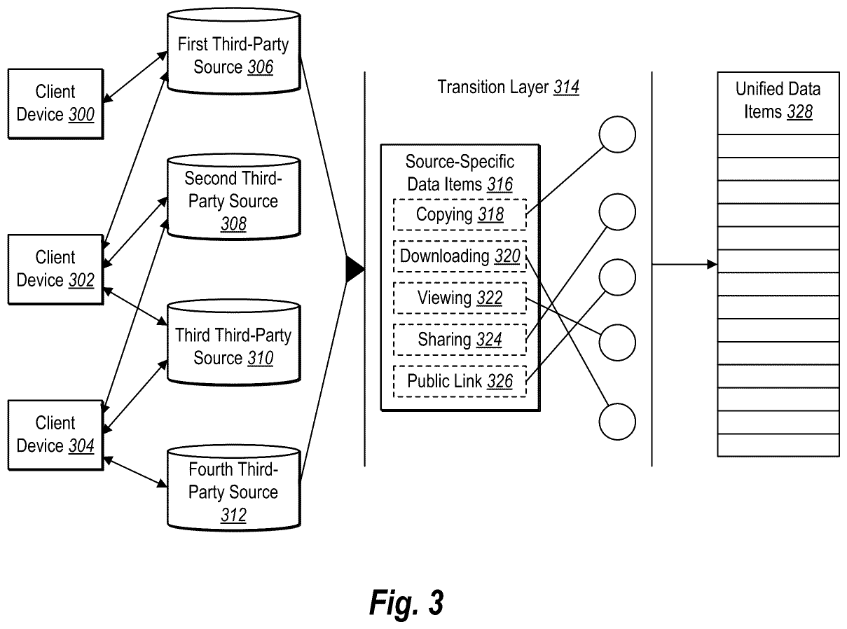

As mentioned above, the unified digital activity system 102 monitors interactions between client devices and third-party sources to generate unified data items. As shown, FIG. 3 illustrates the unified digital activity system 102 using a translation layer to map the source-specific data items coming from different third-party sources to a unified data structure in accordance with one or more embodiments.

As shown, FIG. 3 illustrates the unified digital activity system 102 monitoring/receiving data from client devices. Specifically, FIG. 3 shows a client device 300 interacting with a first third-party source 306 and a client device 302 interacting with the first third-party source 306, a second third-party source 308, and a third third-party source 310. Moreover, FIG. 3 shows a client device 304 interacting with the second third-party source 308, the third third-party source, and a fourth third-party source 312.

As used herein, the term “client device” refers to a computing device part of the content management system 106. Specifically, the content management system 106 can include multiple client devices where each client device has different levels of access, permission, and features available to them. Moreover, the unified digital activity system 102 receives/monitors the digital activity of the client devices interacting with third-party sources (e.g., the first third-party source and the second third-party source).

Accordingly, the content management system 106 contains a plurality of client devices (e.g., tenant devices) that interact with various features provided by the content management system 106. In some embodiments, the client devices of the content management system 106 are internal client devices (e.g., internally part of the same organization associated with the content management system 106). In some embodiments, a subset of the client devices of the content management system 106 are external client devices (e.g., guest devices granted temporary access to various features of the content management system 106).

As mentioned, the unified digital activity system 102 receives data packets from the interactions between the client devices and the third-party sources. As used herein, the term “data packets” refers to information that is collected, observed, measured or generated based on one or more interactions between client devices and third-party sources. Specifically, data packets can include qualitative data that describes information and can further include quantitative data that measures information. For example, the unified digital activity system 102 can receive data packets related to specific client devices, timestamps for activity performed by specific client devices, and actions performed by client devices. Thus, data packets broadly refer to the packets of information exchanged between client devices and third-party sources.

As just mentioned, the data packets can include actions performed by client devices. As used herein, the term “digital activity” refers to client devices interacting with the third-party sources to create content (e.g., create documents), publish documents, grant permissions, remove permissions, send emails, create calendar events, invite additional users, accept calendar events, reject calendar events, create public links, and access certain domain websites.

As mentioned above, the digital activity coming from each third-party source has source-specific data items 316 (e.g., a structure specific to the third-party source it originated from). As shown in FIG. 3, the unified digital activity system 102 receives the source-specific data items 316. In particular, the source-specific data items 316 can include digital activity such as copying 318, downloading 320, viewing 322, sharing 324, and public links 326.

As used herein, the term “copying” refers to an action of duplicating a piece of digital content from one location to another. Specifically, copying refers to making one or multiple copies of a piece of digital content (e.g., text, image, video audio, documents, etc.). Moreover, in some embodiments, the action of copying can further include storing the duplicated digital content in one or more locations and sharing the duplicated digital content to one or more additional devices. As alluded to above, the unified digital activity system 102 analyzes the plurality of unified data items to determine an action of copying.

As used herein, the term “downloading” refers to an action of transferring data from one server (e.g., device) to another server (e.g., a local device). Specifically, the act of downloading allows a client device to obtain and store digital content locally for offline access or use. Moreover, the act of downloading can include transferring data for files, documents, images, video, audio, and software. As alluded to above, the unified digital activity system 102 analyzes the plurality of unified data items to determine an action of downloading.

As used herein, the term “viewing” refers to an action of a client device accessing digital content on the client device. Specifically, the act of viewing includes rendering the content in a format visible on the client device. Moreover, viewing does not require downloading or permanently storing the digital content on the client device. As alluded to above, the unified digital activity system 102 analyzes the plurality of unified data items to determine an action of viewing.

As used herein, the term “sharing” refers to an action of a client device distributing or making digital content accessible to additional client devices (e.g., external or internal). Specifically, the act of sharing can include directly sending the digital content to specific client devices or publicly posting the digital content. As alluded to above, the unified digital activity system 102 analyzes the plurality of unified data items to determine an action of sharing.

As used herein, the term “public link” refers to an action of a client device creating a public link for digital content by generating a URL that provides access to the digital content. Specifically, the public link refers to allowing anyone with the link to view or interact with the content without needing authentication or permissions to access the digital content. As alluded to above, the unified digital activity system 102 analyzes the plurality of unified data items to determine an action of creating a public link.

Moreover, as shown in FIG. 3, the unified digital activity system 102 maps source-specific data structures of the source-specific data items 316 to a unified data structure (e.g., using a translation layer 314) to generate unified data items 328. As used herein, the term “source-specific data structure” refers to a specialized format for organizing, storing, and managing data that is specific to a third-party source. Specifically, the source-specific data structure refers to an organizational or structural style of how a third-party source ingests digital activity. For example, a third-party source records interactions with a plurality of client devices in a specific manner. To illustrate, for a first type of interaction (e.g., granting permissions) with a third-party source, a first third-party source can record that the first type of interaction involved a first client device granting permissions. Moreover, for the first type of interaction, a second third-party source can record that the first type of interaction involved the first client device granting permissions on a specific date.

As used herein, the term “unified data structure” refers to a unified format for organizing, storing, and managing data for all third-party sources integrating with the content management system 106. Specifically, the unified data structure refers to an organization of the data incoming from the third-party sources with a level of detail specified by one or more specifications of the unified digital activity system 102. In other words, the unified digital activity system 102 uses unified naming conventions for all data coming in from the third-party sources.

As used herein, the term “mapping” refers to the unified digital activity system 102 correlating or connecting source specific data items to unified data items. In other words, the unified digital activity system 102 utilizes the translation layer 314 to map or associate source-specific data items with their correct unified data items. Specifically, the unified digital activity system 102 maps a source-specific data structure to the unified data structure.

As mentioned above, the unified digital activity system 102 can further provide a subset of the unified data items to an administrator device. Although not shown in FIG. 3, an administrator device can send a request to the unified digital activity system 102 to provide a subset of unified data items and the unified digital activity system 102 can further utilize a large language model to generate an interpretation/summary of the subset of unified data items.

As used herein, the term “large language model” includes or refers to one or more neural networks capable of processing natural language text to generate outputs that range from predictive outputs, analyses, or combinations of data within stored content items. In particular, a large language model can include parameters trained (e.g., via deep learning) on large amounts of data to learn patterns and rules of language for summarizing and/or generating digital content. Examples of large language model include BLOOM, Bard AI, ChatGPT, LaMDA, DialoGPT, DropboxGPT, and Dropbox FileGPT.

As used herein, the term “summary” refers to a textual description of the subset of unified data items. Specifically, the unified digital activity system 102 can receive a request relating to a specific client device and one or more specific types of digital activity. In addition to providing the subset of unified data items related to the request, the unified digital activity system 102 can further provide a summary (e.g., generated by a large language model) that explains or interprets the subset of unified digital items.

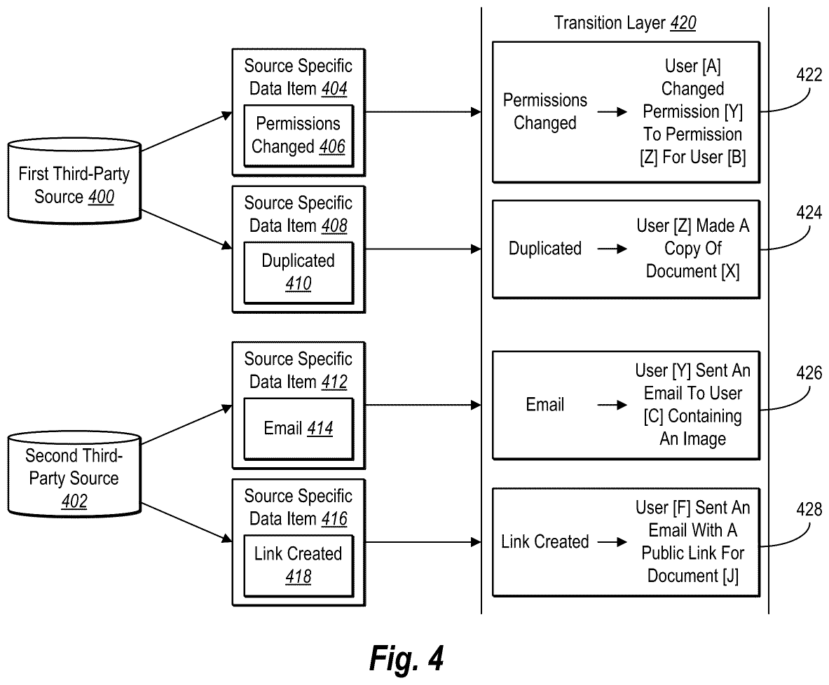

As mentioned above, the unified digital activity system 102 can process and translate source-specific data items to be compatible with the unified data structure. FIG. 4 illustrates the unified digital activity system 102 mapping specific source-specific data items to unified data items in accordance with one or more embodiments.

As shown in FIG. 4, the unified digital activity system 102 receives source-specific data items from a first third-party source 400 and a second third-party source 402. Specifically, FIG. 4 shows the unified digital activity system 102 receiving a source-specific data item 404 of permissions changed 406 and a source-specific data item 408 of duplicated 410 from the first third-party source 400. Additionally, the unified digital activity system 102 receives a source-specific data item 412 of email 414 and a source-specific data item 416 of link created 418 from the second third-party source 402.

As further shown, the unified digital activity system 102 utilizes a translation layer 420 to process the source-specific data items of permission changed 406 and duplicated 410. For instance, the source-specific data item 404 and the source-specific data item 408 originating from the first third-party source 400 can include a file management application. Thus, the unified digital activity system 102 can utilize the translation layer 420 to process the file management specific data items to be compatible with the unified data structure.

In some embodiments, the unified digital activity system 102 references a specification to map the source-specific data items to the unified data items. As used herein, the term “specification” refers to a detailed blueprint that outlines how data from one or more third-party sources should be transformed for the unified digital activity system 102. Specifically, a specification includes specific details of the unified digital activity system 102 processing a source-specific data item (e.g., extracting certain types of metadata and data from data packets from the source-specific data item and translating certain verbiage from the source-specific data item to be compatible with the unified digital activity system 102).

As used herein, the term “first specification” refers to a detailed blueprint specific to a first third-party source. Specifically, the first specification provides instructions for how to extract certain data from data packets and metadata from a source-specific data item originating from the first third-party source. Moreover, the first specification can provide instructions for how to translate a description of a source-specific data item to a unified data item. Thus, as applicable to FIG. 4, the first specification can include instructions for how to process and transform data from a file management system to be compatible with the unified data structure.

Furthermore, FIG. 4 shows the unified digital activity system 102 utilizing the translation layer 420 to process the source-specific data items from the second third-party source 402. In particular, the email 414 and the link created 418 can originate from an email application. Thus, to process the source-specific data items from the second third-party source 402, the unified digital activity system 102 can utilize the translation layer 420 that references a second specification.

As used herein, the term “second specification” refers to a detailed blueprint specific to a second third-party source. Specifically, the second specification provides instructions for how to extract certain data from data packets and metadata from a source-specific data item originating from the second third-party source. Moreover, the second specification can provide instructions for how to translate a description of a source-specific data item to a unified data item.

In one or more embodiments, the unified digital activity system 102 creates the specifications (e.g., for mapping between third-party sources and the unified data structure) by using manual engineering efforts. In particular, the unified digital activity system 102 utilizes manual engineering efforts to carefully consider and incorporate the nuances of security interpretations. In other words, manual engineering efforts can often capture and interpret the nuances of source-specific data items from third-party sources in a manner that artificial intelligence cannot. Thus, manual engineering efforts of parsing through a forensic audit for each third-party source allows for a careful and nuanced understanding of how each system tracks digital activity.

In one or more embodiments, the unified digital activity system 102 creates the specifications by using artificial intelligence. Although, artificial intelligence cannot always capture all the nuances of forensic audits, in some embodiments, the unified digital activity system 102 utilizes machine learning techniques to generate mappings between source-specific data items and the unified data structure. In particular, the unified digital activity system 102 trains a machine learning model by using a source-specific data item to generate a unified data item prediction. Moreover, the unified digital activity system 102 compares the unified data item prediction with a ground truth unified data item. In doing so, the unified digital activity system 102 utilizes the machine learning model to learn parameters of a specification specific to a third-party source.

As used herein, the term “machine learning model” includes a computer algorithm or a collection of computer algorithms that can be trained and/or tuned based on inputs to approximate unknown functions. For example, a machine learning model can include a computer algorithm with branches, weights, or parameters that changed based on training data to improve for a particular task. Thus, a machine learning model can utilize one or more learning techniques (e.g., supervised or unsupervised learning) to improve in accuracy and/or effectiveness. Example machine learning models include various types of decision trees, support vector machines, Bayesian networks, random forest models, or neural networks (e.g., deep neural networks, generative adversarial neural networks, convolutional neural networks, recurrent neural networks, or diffusion neural networks). Similarly, the term “machine learning data” refers to information, data, or files generated or utilized by a machine learning model. Machine learning data can include training data, machine learning parameters, or embeddings/predictions generated by a machine learning model.

Thus, by leveraging artificial intelligence, the unified digital activity system 102 can learn parameters of mapping between various source-specific data items and the unified data items. In doing so, the unified digital activity system 102 can extend the mapping capability of machine learning models to additional source-specific data items not previously seen by the machine learning model. Specifically, the unified digital activity system 102 can generate a specification (e.g., a new mapping) between a new third-party source integrated with the content management system 106 and the unified data structure (e.g., to translate the new source-specific data items to the unified data items).

In some embodiments, the unified digital activity system 102 combines the efforts of manual engineering and trained machine learning models to create one or more specifications. In particular, the unified digital activity system 102 can initially employ trained machine learning models to generate specifications and then utilize manual engineering efforts to double check the work performed by the trained machine learning models. In doing so, the unified digital activity system 102 can conserve computational efforts and more efficiently create specifications between third-party sources and the unified data structure.

Moreover, in some embodiments, the unified digital activity system 102 uses a repository of created specifications and tailors one or more of the specifications to match the conventions of a specific third-party source. In other words, the unified digital activity system 102 can draw upon existing specifications to avoid redoing prior efforts and can use one or more trained machine learning models to fine-tune the specifications to conform with different third-party source requirements. Moreover, in some embodiments, the unified digital activity system 102 can use manual engineering efforts to tweak existing specifications to conform with third-party source requirements. In some embodiments, the unified digital activity system 102 uses a combination of trained machine learning models and manual engineering efforts to tweak existing specifications.

As mentioned above, third-party sources use a variety of naming conventions to label monitored interactions. As used herein, the term “naming convention” refers to a systematic set of rules used to assign names to source-specific data items. Specifically, a naming convention for a first third-party data source can include “permissions,” “link,” “email,” and “copy.” Moreover, a naming convention for a second third-party data source can include “permissions granted by user [A],” “public link,” “email received,” and “copy by user [A].” In other words, despite the digital activities being similar, naming conventions can differ from third-party source to third-party source.

As mentioned above, the unified digital activity system 102 unifies the naming conventions of source-specific data items. As used herein, the term “unified naming convention” refers to a set of rules and guidelines established by the unified digital activity system 102 for translating the naming conventions of the source-specific data items to unified naming conventions. As mentioned above, the unified digital activity system 102 can reference one or more specifications to determine how to translate the naming conventions of the source-specific data items to unified naming conventions.

FIG. 4 further shows the unified digital activity system 102 using the translation layer 420 to generate a first translation 422, a second translation 424, a third translation 426, and a fourth translation 428. Specifically, the first translation 422 shows permissions changed 406 translated to “user [A] changed permission [Y] to permission[Z] for user [B].” Further the second translation 424 shows duplicated 410 translated to “user [z] made a copy of document [x].” Moreover, the third translation 426 shows email 414 translated to “user [Y] sent an email to user [C] containing an image.” Furthermore, the fourth translation 428 shows link created 418 translated to “user [F] sent an email with a public link for document [j].” Thus, FIG. 4 demonstrates that the unified digital activity system 102 can provide a level of granularity that is both meaningful and intelligible to an administrator device.

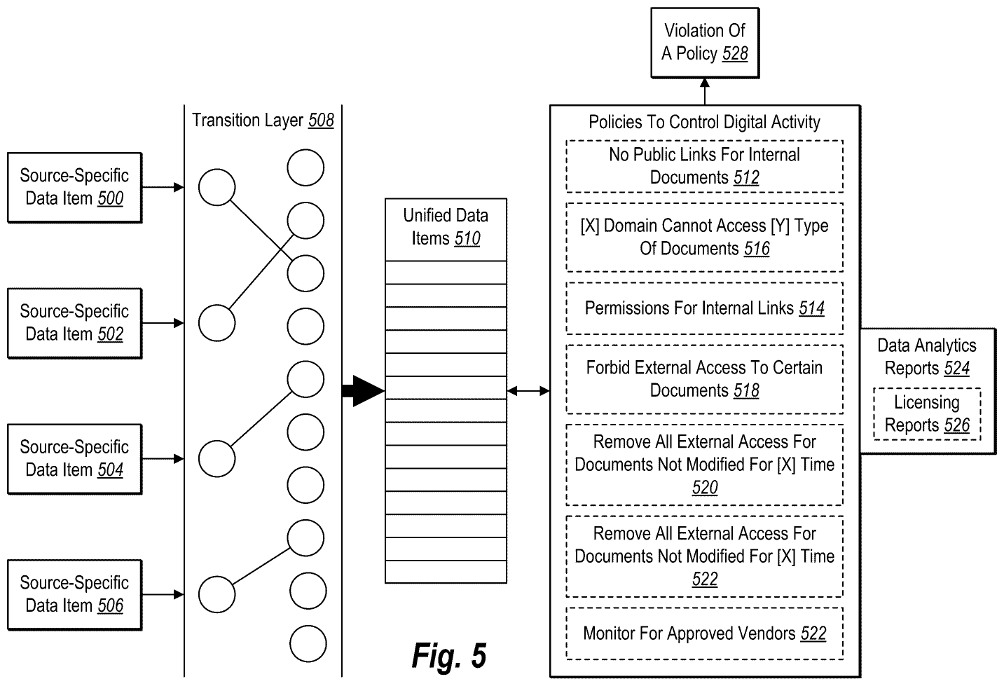

As mentioned above, the unified digital activity system 102 can manage and enforce customer implemented digital security policies based on analyzing the unified data items. FIG. 5 illustrates the unified digital activity system 102 monitoring the unified data items and the policies to control digital activity to detect a violation of a policy in accordance with one or more embodiments.

As shown in FIG. 5, the unified digital activity system 102 receives source-specific data items 500-506 and uses a translation layer 508 to process the source-specific data items 500-506. As previously mentioned, the unified digital activity system 102 maps the source-specific data items 500-506 to a unified data structure to generate unified data items 510.

As further shown, the unified digital activity system 102 compares the unified data items 510 to policies to control digital activity. In one or more embodiments, the unified digital activity system 102 generates pre-established policies and allows administrator devices to fine-tune or modify the pre-established policies. In one or more embodiments, the unified digital activity system 102 receives the policies from the administrator devices.

As used herein, the term “policy” refers to a set of rules that govern the use of third-party sources within the content management system 106. Specifically, a policy refers to the unified digital activity system 102 controlling behaviors, functions, and actions taken by client devices using third-party sources.

As shown in FIG. 5, the policies to control digital activity includes policy for public links 512, policy for permissions 514, policy for external access 516-520, and policy for approved third-party sources 522. As used herein, the term “policy for public links” refers to a set of rules that govern the creation of public links by client devices in the content management system 106. Specifically, the policy for public links can be a broad provision that forbids all creation of public links, or the policy can include a narrower provision that forbids the creation of public links for specific types of documents. For example, the unified digital activity system 102 can analyze the unified data items to determine which unified data items indicate a public link and then compare the subset of unified data items to the established policies related to public links.

As used herein, the term “policy for permissions” refers to a set of rules that governs permissions for content items. Specifically, policy for permission can include broad provisions that govern who can change what types of permissions. Moreover, the policy for permissions can include narrower provisions that govern when certain permissions for certain documents will automatically change (e.g., a document that has not been modified for over a year is no longer modifiable). For instance, the unified digital activity system 102 analyzes the unified data items to determine whether policy for permissions is being violated. To illustrate, the unified digital activity system can identify a specific client device granting permission to another client device and then determining whether the specific client device has credentials to do so.

As used herein, the term “policy for external access” refers to a set of rules that governs external access for content items on the content management system 106. Specifically, the policy for external access can indicate specific email domains that can or cannot access content items. For example, the unified digital activity system 102 can analyze unified data items to determine access by all client devices and then further identify client devices that are considered external to the content management system 106.

As used herein, the term “approved third-party sources” refers to a set of rules that govern the use of certain third-party sources. Specifically, the content management system 106 can have approved third-party sources, and third-party sources not part of the approved third-party sources are not permitted. For example, the unified digital activity system 102 can compare use of third-party sources by client devices (e.g., based on the unified data items indicating digital activity and the third-party source that the digital activity originated from) and determine which use falls outside of the approved third-party sources.

As illustrated, the unified digital activity system 102 compares the unified data items 510 with the policies to control digital activity. As shown in FIG. 5, from the comparison, the unified digital activity system 102 determines a violation 528 of a policy. Specifically, a “violation” of a policy refers to an action or behavior based on the unified data items 510 that goes against the established policies.

In one or more embodiments, the unified digital activity system 102 can detect the violation 528 of a policy by actively monitoring the unified data items and comparing them to the policies to control digital activity. For instance, as client devices of the content management system 106 are interacting with various third-party sources, the unified digital activity system 102 receives the source-specific data items and translates them into the unified data items 510. Specifically, as the unified digital activity system 102 receives the unified data items 510, the unified digital activity system 102 triggers a monitoring action of comparing each unified data item to each of the policies. In detecting a violation, the unified digital activity system 102 flags the unified data item that violated one or more policies and provides a notification to an administrator device.

In some embodiments, the unified digital activity system 102 passively monitors the unified data items. For instance, passively monitoring includes the unified digital activity system 102 comparing the unified data items to each of the policies (e.g., as they are received) and flagging unified data items that violate policies. However, the unified digital activity system 102 does not notify an administrator device until queried by an administrator device. Thus, the unified digital activity system 102 alerts an administrator device when the administrator device queries the unified digital activity system 102 for information.

In addition to detecting the violation 528, the unified digital activity system 102 can further provide data analytic reports 524 to an administrator device. As used herein, the term “data analytics report” refers to a digital report recounting statistics of the digital activity of one or more client devices interacting with third-party sources. Specifically, the data analytics report can include statistical reports for resource usage, the most common digital activity, the least common digital activity, and breakdowns for usage by different client devices. To illustrate, the unified digital activity system 102 can provide resource usage reports to an administrator device to determine third-party source usage. In particular, the resource usage reports can help an administrator device identify efficiency for a number of license (e.g., license seats) related to a specific third-party source (e.g., licensing reports 526).

For instance, the unified digital activity system 102 tracks how many client devices accesses a specific third-party source (e.g., a digital illustration application). Specifically, the organization associated with the content management system 106 may have five hundred licenses for using the specific third-party source, but tracking data indicates only two hundred and fifty client devices use the specific third-party source on a regular basis. As such, the unified digital activity system 102 can generate a report regarding the usage of a specific third-party source and provide the report to an administrator device.

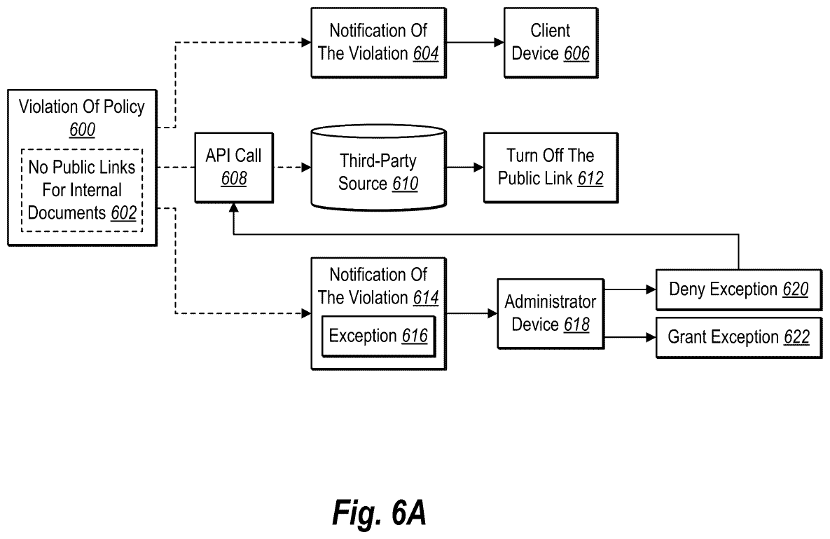

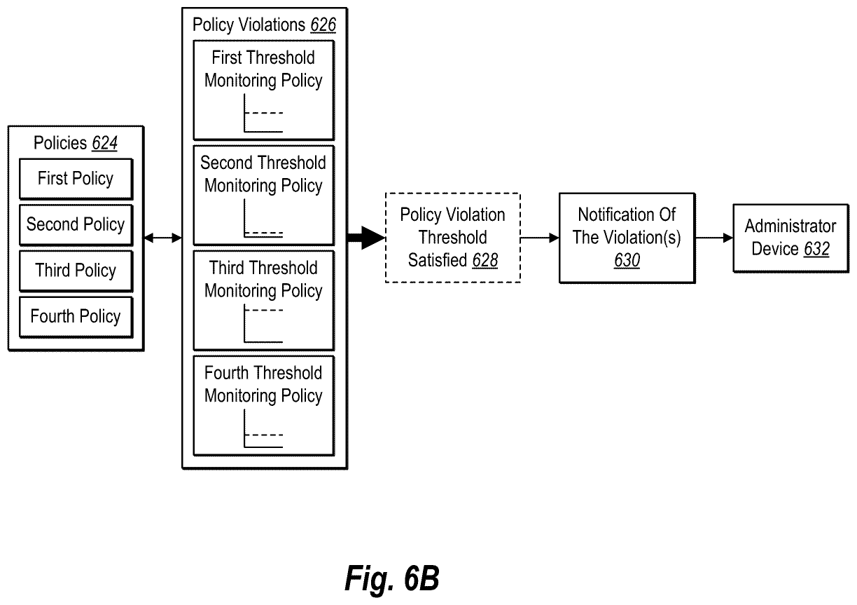

As mentioned above, the unified digital activity system 102 can perform one or more operations in response to determining a violation of a policy. FIG. 6A illustrates the unified digital activity system 102 detecting a violation of a policy and performing various operations in accordance with one or more embodiments.

As shown in FIG. 6A, the unified digital activity system 102 detects a violation 600 of a policy, where the violation 600 includes violating a policy 602 of “no public links for internal documents.” In response to detecting the violation 600, the unified digital activity system 102 can perform any combination of or all the paths shown in FIG. 6A. In one or more embodiments, the unified digital activity system 102 generates a notification 604 of the violation.

As used herein a “notification” refers to a message or alert to inform a computing device regarding a specific event. Specifically, the notification can include a message or alert sent to an administrator or to a client device. For instance, a notification sent to an administrator can include an alert that a policy has been violated and, in some embodiments, the notification can further include an exception to the policy. In some embodiments, the notification to the client device can include a message to notify the client device that one or more digital activities violated a specific policy.

As shown, the unified digital activity system 102 generates the notification 604 and provides the notification 604 to a client device 606. In particular, the unified digital activity system 102 identifies the client device 606 as the device that performed the violation 600. Furthermore, the notification 604 provided to the client device 606 can include various options to contact an administrator device or for the client device 606 to reverse the action that initially violated the policy 602.

In one or more embodiments, the unified digital activity system 102 detects the violation 600 and further sends an application programming interface call, hereinafter referred to as an API call 608 to a third-party source 610 where the violation 600 occurred. As used herein an “API call” includes a set of protocols, routines, and tools for building applications. In particular, an API provides a method for various software components, applications, or systems to communicate and exchange data with one another, regardless of the type of programming language, operating system, or hardware platforms used for each application environment. For instance, an API can include a set of rules that define the manner in which different software components interact, the format and structure of data exchange, the syntax and parameters of calls, and the methods for authentication.

As shown, the unified digital activity system 102 uses the API call 608 to cause the third-party source 610 to reverse the action that initially caused the violation 600. Specifically, the policy 602 shown in FIG. 6A is that public links are not to be created for internal documents. To enforce this policy, the unified digital activity system 102 sends the API call 608 to the third-party source 610 to cause the third-party source 610 to turn off the specifically created public link (e.g., perform an act 612) that resulted in the violation 600.

In one or more embodiments, the unified digital activity system 102 generates a notification 614 of the violation 600. As shown in FIG. 6A, the notification 614 includes an exception 616. As used herein, the term “exception” refers to an exception to one or more of the established policies. Specifically, an exception refers to a policy of the unified digital activity system 102 being violated and the unified digital activity system 102 allowing the violation to persist. For example, the unified digital activity system 102 can send a notification to an administrator device with the ability to grant an exception to the detected violation. In response to the administrator device granting the exception, the unified digital activity system 102 can allow the violation to persist.

As further shown, the unified digital activity system 102 provides the notification 614 with the exception 616 to an administrator device 618. Moreover, the administrator device 618 has the option to deny 620 the exception or to grant 622 the exception. As shown in FIG. 6A, if the unified digital activity system 102 receives an indication from the administrator device 618 that the exception is granted, the unified digital activity system 102 allows the violation 600 to persist (e.g., the unified digital activity system 102 does not turn off the public link). As further shown in FIG. 6A, if the unified digital activity system 102 receives an indication from the administrator device 618 that the exception is denied, the unified digital activity system 102 sends the API call 608 to the third-party source 610 and turns off the public link.

FIG. 6B further illustrates the unified digital activity system 102 establishing a policy violation threshold to determine when to notify an administrator device regarding a violation of a policy in accordance with one or more embodiments. For example, some policy violations may be less serious (e.g., relative to leaking confidential information via a public link) and may involve using certain websites that are considered lower risk (e.g., watching a cat video on a video website). As such, the unified digital activity system 102 can establish thresholding policies that indicate a number of violations that need to be committed by a client device before the violation rises to a level of seriousness that an administrator device needs to deal with the violation.

As shown in FIG. 6B, the unified digital activity system 102 establishes policies 624 that include a first policy, a second policy, a third policy, and a fourth policy. Furthermore, the unified digital activity system 102 monitors the policies 624 by comparing the incoming unified data items with the policies 624. Specifically, the unified digital activity system 102 detects policy violations 626 and identifies whether the detected policy violations 626 contain a threshold monitoring policy.

IAs used herein, the term “threshold monitoring policy” refers to establishing a baseline for a number of violations for a specific policy before the unified digital activity system 102 sends a notification to one or more client devices. For example, if a policy exists that video links cannot be sent from client devices part of the content management system 106, the policy can have a threshold monitoring policy of twenty video links sent before the unified digital activity system 102 sends a notification to the administrator device.

As shown in FIG. 6B, the policy violations 626 contain a first threshold monitoring policy, a second threshold monitoring policy, a third threshold monitoring policy, and a fourth threshold monitoring policy. Each of the established threshold monitoring policies correspond to a different policy. For instance, the first policy corresponds to the first threshold monitoring policy, the second policy corresponds to the second threshold monitoring policy, and so forth. As shown in FIG. 6B, the second threshold monitoring policy has a much lower threshold (e.g., of policy violations) then the third threshold monitoring policy. In particular, the lower threshold can indicate a more serious violation.

As shown in FIG. 6B, the unified digital activity system 102 monitors the threshold monitoring policies based on the incoming policy violations. In some embodiments, the unified digital activity system 102 determines that a policy violation threshold has been satisfied 628. For instance, if the first policy was violated, and the first policy has a first threshold monitoring policy of twenty violations, once the twenty violations is reached, the unified digital activity system 102 generates a notification 630 of the violations. Moreover, as shown, the unified digital activity system 102 provides the notification 630 to an administrator device 632.

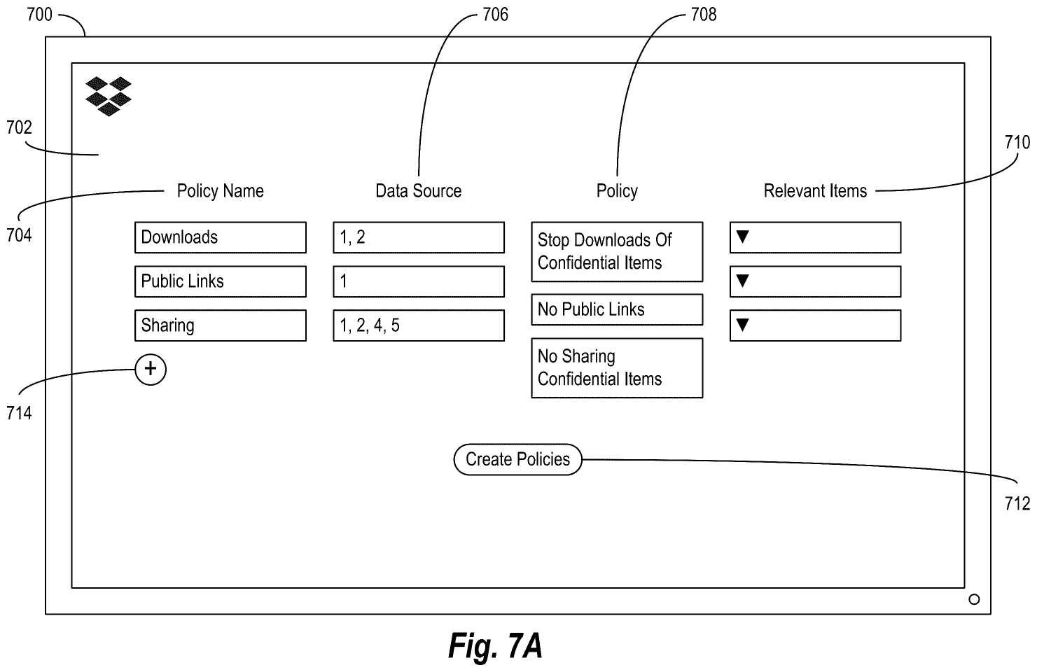

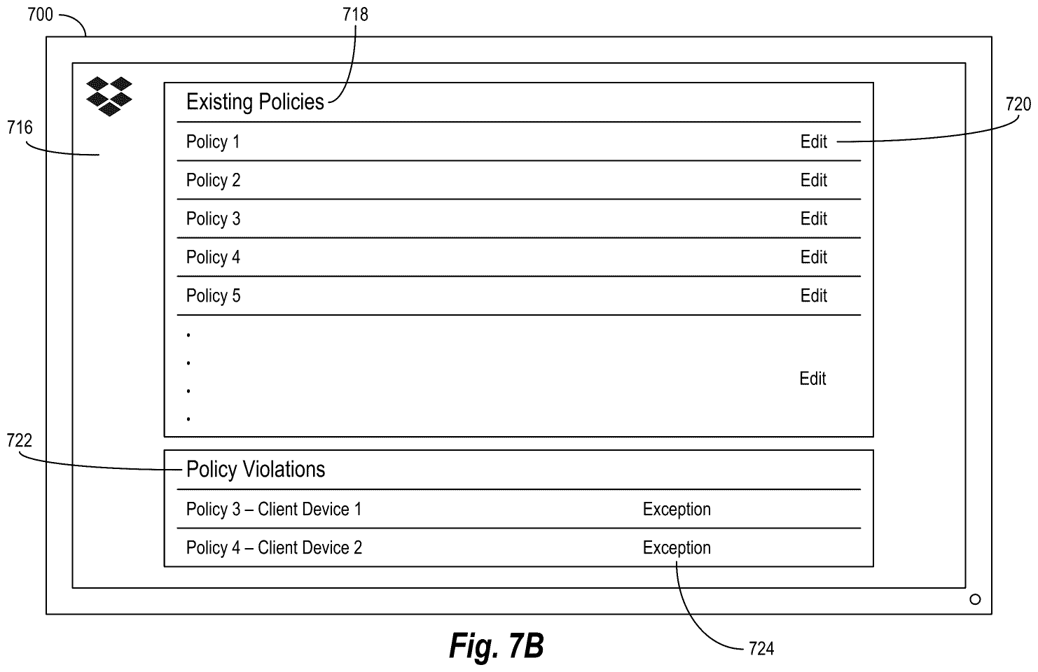

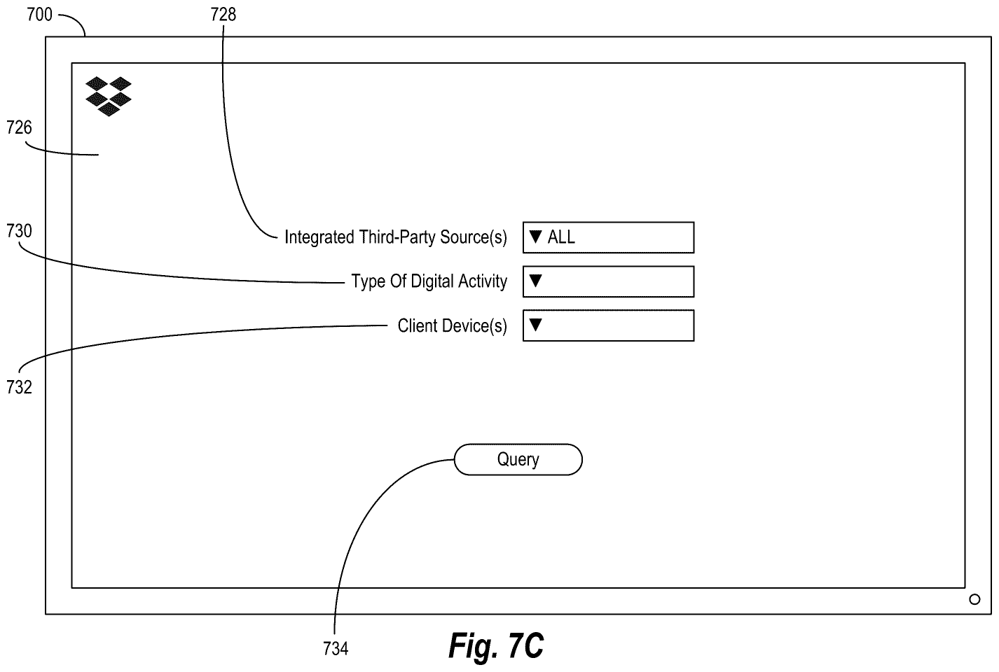

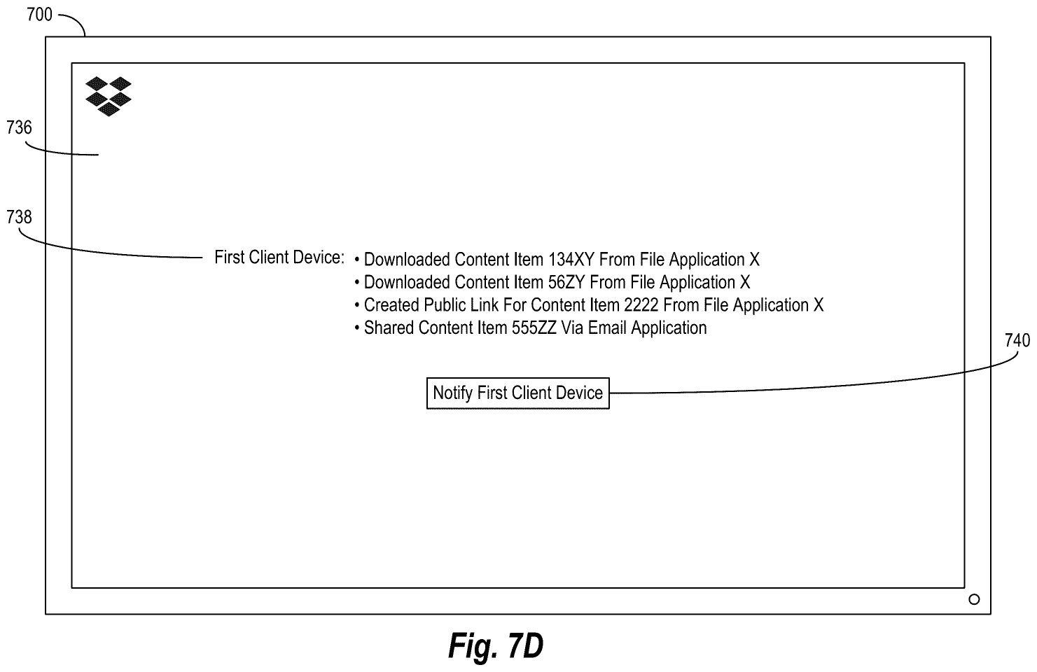

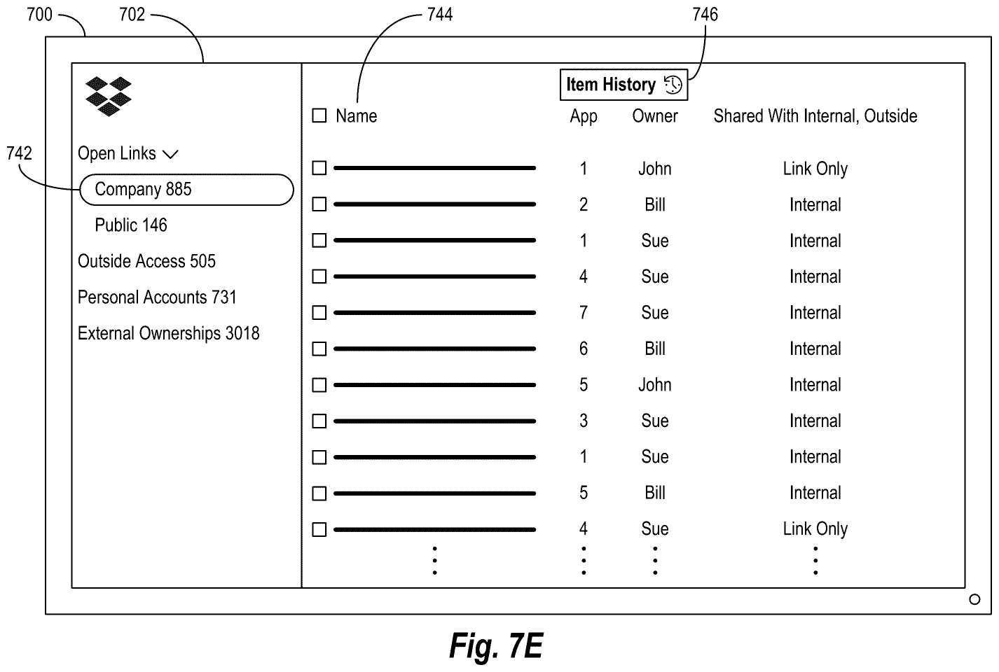

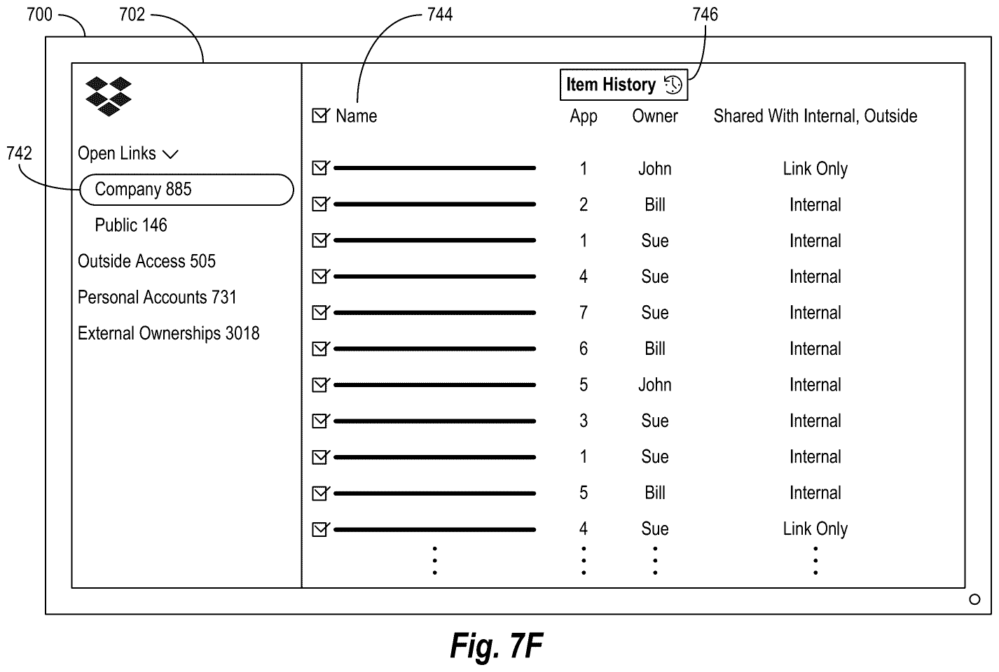

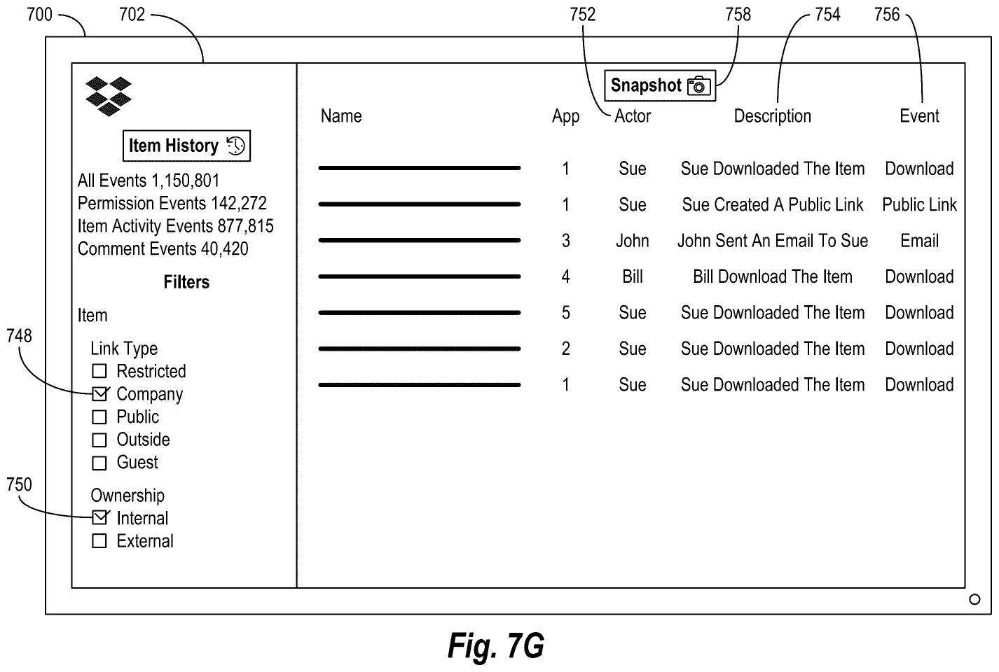

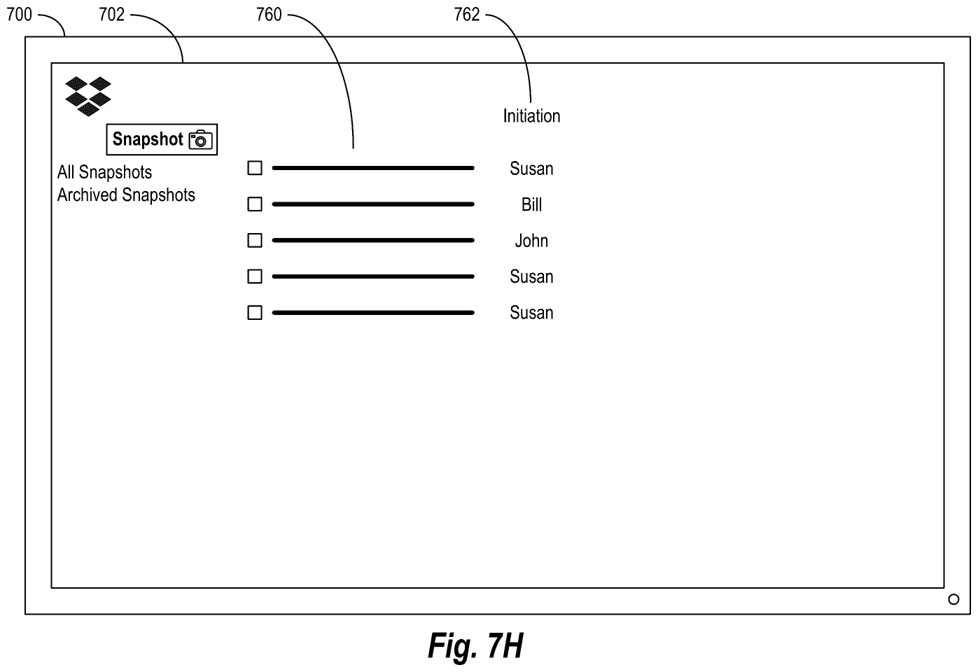

As mentioned above, the unified digital activity system 102 provides various tools to an administrator device to configure policies, to query the unified digital activity system 102, and to provide exceptions to a policy. FIGS. 7A-7D illustrate a series of graphical user interfaces for an administrator device to perform one or more actions in accordance with one or more embodiments.

In one or more embodiments, the unified digital activity system 102 provides a seamless interface for an administrator device to manage, create, and view policies. In particular, the interface provided by the unified digital activity system 102 allows for the administrator device to view information related to the unified digital activity system 102 within a single user interface (e.g., without having to shuffle between multiple interfaces). For instance, the unified digital activity system 102 provides the interface which allows an administrator device to add filters to unified data items, query for a subset of unified data items, create policies, grant exceptions to policies, edit existing policies, etc.

For example, FIG. 7A illustrates a graphical user interface 702 of an administrator device 700 for creating one or more policies. Specifically, FIG. 7A shows the graphical user interface 702 displaying a policy name 704, a data source 706, a policy 708, and relevant items 710. For instance, the policy name allows an administrator device to provide a name (e.g., reference, nickname, etc.) to a created policy (e.g., downloads, public links, and sharing). Furthermore, the graphical user interface 702 shows the data source 706 which indicates a third-party source with an applied policy. In particular, the graphical user interface 702 shows specific numbers (e.g., 1, 2, 4, 5). In one or more embodiments, each number indicates a specific third-party source (e.g., 1 points to a third-party file management application). Thus, the policy for public links applies to a first third-party source, the policy for downloads applies to the first and second third-party source, and the policy for sharing applies to the first, second, fourth, and fifth third-party source.

In addition, the policy 708 indicates the specific type of action enforced by the unified digital activity system 102. For instance, the graphical user interface 702 shown in FIG. 7A indicates for the policy “download,” that the policy is to stop a client device from downloading of confidential items. Moreover, the policy 708 shows that for public links, there is a policy of no public links, and for the policy of sharing, there is a policy of no sharing confidential items.

Moreover, FIG. 7A shows the relevant items 710 which provides an option for the administrator device 700 to indicate which files/content items/folders are relevant to the policies. Specifically, the unified digital activity system 102 can indicate all content items/files that cannot be downloaded because they are considered confidential. For instance, upon selection of the down arrow for the relevant items 710, the unified digital activity system 102 provides an option to search for specific content items, to navigate through folders, to designate entire folders as confidential, and to designate multiple folders as confidential. Thus, the unified digital activity system 102 can receive all the relevant items 710 for each of the policies.

In addition, FIG. 7A shows that the graphical user interface 702 includes an activate policy element 714 that can be selected to setup and activate a specific policy for specified data sources. Moreover, FIG. 7A indicates that graphical user interface 702 includes a create policies element 712 to allow a user of the administrator device to create a new policy that can be selected when activating a policy using the activate policy element 714.

FIG. 7B illustrates the graphical user interface 716 of the administrator device 700 managing one or more existing policies and policy violations in accordance with one or more embodiments. For example, FIG. 7B shows the graphical user interface 716 displaying existing policies 718. Specifically, the existing policies 718 include a first policy, a second policy, a third policy, a fourth policy, and a fifth policy. Moreover, the graphical user interface 716 further provides an edit option 720 to edit the existing policies 718.

In addition to the existing policies 718, the unified digital activity system 102 further shows policy violations 722. For example, the policy violations 722 indicate when one or more of the existing policies have been violated. Specifically, as described above, the unified digital activity system receives incoming source-specific data items from various third-party sources and translates the source-specific data items into unified data items. Furthermore, the unified digital activity system 102 monitors the unified data items by comparing them to the existing policies 718 and determines when one or more of the policies have been violated.

To illustrate, FIG. 7B shows the policy violations 722 include a third policy violated by a first client device and a fourth policy violated by a second client device. For instance, the violation by the first client device can include the first client device downloading a confidential item and the violation by the second client device can include the second client device creating a public link for a web page (e.g., to share on social media). As shown, the graphical user interface 716 further displays an exception option 724 for the administrator device 700 to approve one or more of the policy violations 722. In particular, the administrator device 700 can grant an exception for the second client device and enforce the policy for the policy violation of the first client device.

FIG. 7C illustrates a graphical user interface of the administrator device creating a query in accordance with one or more embodiments. For example, FIG. 7C shows a graphical user interface 726 of the administrator device 700 which includes an option to indicate integrated third-party source(s) 728, type of digital activity 730, and client device(s) 732. Specifically, the integrated third-party source(s) 728 allows the administrator device 700 to select one or more third-party sources. For instance, FIG. 7C shows the administrator device 700 selecting ALL third-party sources. In some embodiments, the administrator device 700 selects a third-party email application, a third-party file management application, and a third-party calendar application.

Moreover, FIG. 7C shows the type of digital activity 730 which provides an option for the administrator device 700 to select one or more types of digital activity 730. Specifically, the administrator device 700 can select downloading confidential information, creating public links, and sharing confidential information. In addition, the client device(s) 732 provides an option for the administrator device 700 to select one or more client devices to determine whether the selected one or more client devices performed the indicated types of digital activity (e.g., using the integrated third-party sources).

As shown in FIG. 7C, the graphical user interface 726 further displays a query element 734. In particular, selecting the query element 734 causes the unified digital activity system 102 to generate a subset of unified data items that relate to the selected elements (e.g., the third-party source, the type of digital activity, and/or the client device(s)). For instance, the unified digital activity system 102 processes the query by filtering the unified data items based on integrated third-party sources, the type of digital activity, and/or the client device(s) and further identifies a subset of the unified data items that correspond to the query.

Although FIG. 7C shows the integrated third-party source(s) 728, the type of digital activity 730, and the client device(s) 732, in one or more embodiments, one or more of the presented elements are optional. For instance, the administrator device 700 can create a query that just points to the integrated third-party sources and the types of digital activity.

FIG. 7D illustrates the unified digital activity system 102 providing a report that is responsive to an administrator query to a graphical user interface of the administrator device in accordance with one or more embodiments. For example, FIG. 7D shows a graphical user interface 736 of the administrator device 700 that displays digital activity of a first client device 738. In particular, the unified digital activity system 102 first receives a query from the administrator device 700 indicating all the third-party sources, digital activity types (e.g., downloads, public links, and shared items) and the first client device 738. In response to the query from the administrator device 700, the unified digital activity system 102 can filter the unified data items to obtain the information shown in FIG. 7D.

To illustrate, FIG. 7D shows that the first client device 1) downloaded content item 134XY from file application X, 2) downloaded content item 56ZY from file application X, 3) created a public link for content item 2222 from file application X, and shared content item 555ZZ via an email application. In one or more embodiments, the detected digital activity for the first client device 738 indicates policy violations. In some embodiments, the information shown in FIG. 7B shows the digital activity performed by the first client device 738 within a predetermined window of time (e.g., which can be indicated in an administrator query). In such cases, the administrator device 700 can further query the unified digital activity system 102 to determine which of the activities by the specific device amounted to a policy violation.

As further shown in FIG. 7D, the unified digital activity system 102 further provides a notify element 740 in the graphical user interface 736 of the administrator device 700. For instance, in response to a selection of the notify element 740, the unified digital activity system 102 can generate a notification for the violations committed by the first client device 738 and send the notification to the first client device 738. In some embodiments, the unified digital activity system 102 can generate a notification for each of the policy violations. For instance, the notification provided to the first client device 738 can indicate that the existing policy, the nature of the violation committed by the first client device 738, and that the policy is being enforced. In some embodiments, the notification to the first client device 738 can further include an option to contact the administrator device 700.

FIG. 7E illustrates the unified digital activity system 102 providing a graphical user interface to a client device, such as an administrator device. For example, FIG. 7E shows the client device 700 with the graphical user interface 702 and further shows a more detailed interface (e.g., relative to FIGS. 7A-7D) for filtering/parsing through unified data items. Specifically, FIG. 7E shows a selection of a graphical user interface element 742 (e.g., “company”), which causes the unified digital activity system 102 to provide for display unified data items relevant to the selected graphical user interface element 742. For instance, FIG. 7E shows the documents or unified data items that are restricted to company use (e.g., as opposed to public use).

As shown, FIG. 7E shows a name element 744 of the unified data items, a relevant application (e.g., a third-party application source), an owner of the unified data item, and a shared with status (e.g., internal, outside, and/or link only). Additionally, FIG. 7E shows the unified digital activity system 102 providing an item history element 746. Specifically, in response to a selection of the item history element 746, the unified digital activity system 102 causes the graphical user interface 702 to display event behavior based for the unified data items based on item metadata.

FIG. 7F illustrates the unified digital activity system 102 receiving a selection of all the shown unified data items (e.g., documents) in the graphical user interface 702. Furthermore, in addition to receiving a selection of the shown unified data items, FIG. 7F shows the unified digital activity system 102 receiving a selection of the item history element 746. In some embodiments, the unified digital activity system 102 receives only a selection of a subset of the shown unified data items.

In response to the selection of the item history element 746, the unified digital activity system 102 provides for the graphical user interface 702 shown in FIG. 7G. For example, FIG. 7G shows the event behavior based on the item metadata. In other words, FIG. 7E shows a plurality of unified data items (e.g., document X, document Y, document Z) whereas FIG. 7G shows events for each of the unified data items (event 1 for document X, event 2 for document X, event 3 for document X, etc.). Specifically, FIG. 7G shows that the unified data items were filtered by a link type element 748 (e.g., company) and an ownership type element 750 (e.g., internal). For instance, the unified digital activity system 102 can fetch the relevant unified data items (filtered by the link type element 748 and the ownership type element 750) by using a unique identifier associated with one or more selected filters. To illustrate, unified data items that contain the filter for both the link type element 748 and the ownership type element 750 include a common identifier. Thus, the link type element 748 and the ownership type element 750 parses a database of stored unified data items to locate all unified data items that match the unique identifier.

Further, FIG. 7G shows an actor 752 for the event behaviors, a description 754 of the event and an event 756. For instance, for a first unified data item, FIG. 7G shows an associated third-party source (third-party source 1), the actor 752 (Sue), the description 754 (Sue downloaded the item), and the event 756 (download). Additionally, FIG. 7G shows a snapshot element 758, which in response to a selection of the snapshot element 758, the unified digital activity system 102 saves and stores a record of the unified data items according to the selected filters (e.g., the link type element 748 (e.g., company) and the ownership type element 750 (e.g., internal). Moreover, FIG. 7G further shows that an administrator device can further filter the item history by additional filters such as “public,” “outside,” “guest,” “restricted,” and “external.” In other words, the unified digital activity system 102 provides a variety of options to pivot to different subsets/subsections of the unified digital items.

FIG. 7H illustrates the unified digital activity system 102 providing for display the graphical user interface 702 in response to a selection of the snapshot element 758. For example, FIG. 7H shows a plurality of snapshots 760 and initiation 762 that indicates a user associated with a client device that initiated a snapshot. In response to a selection of a snapshot of the plurality of snapshots 760, the unified digital activity system 102 shows the related unified data items, the actor 752, the description 754, and the event 756. In other words, the unified digital activity system 102 assists an administrator device in collecting forensic details/evidence (e.g., for auditing an organization) for a specific actor, or type of event. Thus, as shown in FIGS. 7E-7H, the unified digital activity system 102 provides efficient and accurate tools for filtering unified data items and storing data related to the unified data items.

FIGS. 1-7, the corresponding text, and the examples provide a number of different systems and methods for generating unified data items from source-specific data items. In addition to the foregoing, implementations can also be described in terms of flowcharts comprising acts steps in a method for accomplishing a particular result. For example, FIG. 8 illustrates an example series of acts performed by the unified digital activity system.

While FIG. 8 illustrates acts according to certain implementations, alternative implementations may omit, add to, reorder, and/or modify any of the acts shown in FIG. 8. The acts of FIG. 8 can be performed as part of a method. Alternatively, a non-transitory computer-readable medium can comprise instructions, that when executed by one or more processors, cause a computing device to perform the acts of FIG. 8. In still further implementations, a system can perform the acts of FIG. 8.

As illustrated in FIG. 8, a series of acts 800 that may include an act 802 of receiving a plurality of source-specific data items from a first third-party source and a second third-party source, an act 804 of generating, from the plurality of source-specific data items, a plurality of unified data items, an act 806 of identifying a subset of unified data items from the plurality of unified data items by processing the request using the unified data structure, and an act 808 of providing the subset of unified data items to an administrator device.

The act 802 includes receiving a plurality of source-specific data items from a first third-party source and a second third-party source, the plurality of source-specific data items comprising data representing digital activity of a plurality of client devices using the first third-party source and the second third-party source. Further, the act 804 includes generating, from the plurality of source-specific data items, a plurality of unified data items by utilizing a translation layer that maps source-specific data structures to a unified data structure. Moreover, the act 806 includes identifying, based on a request from an administrator device, a subset of unified data items from the plurality of unified data items by processing the request using the unified data structure, the subset of unified data items being based on source-specific data items from both the first third-party source and the second third-party source. Further, the act 808 includes providing the subset of unified data items to the administrator device.

Further, in one or more embodiments the series of acts 800 includes that the plurality of source-specific data items comprises an indication of digital activity corresponding to the plurality of client devices comprising at least one of copying, downloading, viewing, sharing, or creating a public link. Additionally, in one or more embodiments the series of acts 800 includes mapping a first source-specific data structure of the first third-party source to the unified data structure by referencing a first specification that indicates a naming convention of the first source-specific data structure corresponds to a first unified naming convention of the unified data structure. Moreover, in one or more embodiments the series of acts 800 includes mapping a second source-specific data structure of the second third-party source to the unified data structure by referencing a second specification that indicates a naming convention of the second source-specific data structure corresponds to a second unified naming convention of the unified data structure.

Furthermore, in one or more embodiments the series of acts 800 includes receiving the request comprising a query relating to a first type of digital activity and a second type of digital activity for a first client device of the plurality of client devices. Additionally, in one or more embodiments the series of acts 800 includes identifying the subset of unified data items comprising the source-specific data items for the first type of digital activity and the second type of digital activity for the first client device, wherein the first type of digital activity and the second type of digital activity for the first client device are performed on both the first third-party source and the second third-party source. Moreover, in one or more embodiments the series of acts 800 includes generating a policy to control digital activity of the plurality of client devices using the first third-party source and the second third-party source. Further, in one or more embodiments the series of acts 800 includes detecting that digital activity of a client device from the plurality of client devices violated the policy on the first third-party source by analyzing the plurality of unified data items from the plurality of client devices. Moreover, in one or more embodiments the series of acts 800 includes causing the first third-party source to enforce the policy by reversing the digital activity of the client device. Further, in one or more embodiments the series of acts 800 includes sending a notification to the client device regarding the violation of the policy.

Further, in one or more embodiments the series of acts 800 includes generating a policy to control digital activity of the plurality of client devices using the first third-party source and the second third-party source. Moreover, in one or more embodiments the series of acts 800 includes detecting a violation of the policy by a client device of the plurality of client devices. Additionally, in one or more embodiments the series of acts 800 includes sending a notification to the administrator device to provide an exception to the policy for the client device.

In one or more embodiments the series of acts 800 includes generating a policy to control digital activity of the plurality of client devices using the first third-party source and the second third-party source. Moreover, in one or more embodiments the series of acts 800 includes establishing a threshold monitoring policy for the policy. Further, in one or more embodiments the series of acts 800 includes detecting a plurality of violations of the policy that satisfies the threshold monitoring policy by monitoring the plurality of unified data items. In one or more embodiments the series of acts 800 includes in response to detecting the plurality of violations, sending a notification to the administrator device regarding the plurality of violations.

Further, in one or more embodiments the series of acts 800 includes generating, utilizing a large language model, a summary of the subset of unified data items from both the first third-party source and the second third-party source. Moreover, in one or more embodiments the series of acts 800 includes providing the summary of the subset of unified data items to the administrator device.

Further, in one or more embodiments the series of acts 800 includes monitoring the plurality of unified data items from the plurality of client devices to determine that a client device accessed a third third-party source. Moreover, in one or more embodiments the series of acts 800 includes comparing the third third-party source to a database of approved third-party sources. Additionally, in one or more embodiments the series of acts 800 includes in response to determining that the third third-party source is not an approved third-party source, sending a notification to the administrator device.

In one or more embodiments the series of acts 800 includes receiving a plurality of source-specific data items from a first third-party source and a second third-party source, the plurality of source-specific data items comprising data representing digital activity of a plurality of client devices using the first third-party source and the second third-party source. Moreover, in one or more embodiments the series of acts 800 includes generating, from the plurality of source-specific data items, a plurality of unified data items by utilizing a translation layer that maps a first source-specific data structure of the first third-party source and a second source-specific data structure of the second third-party source to a unified data structure. Additionally, in one or more embodiments the series of acts 800 includes identifying, based on a request from an administrator device, a subset of unified data items from the plurality of unified data items by processing the request using the unified data structure, the subset of unified data items being based on source-specific data items from both the first third-party source and the second third-party source. In one or more embodiments the series of acts 800 includes providing the subset of unified data items to the administrator device.

Further, in one or more embodiments the series of acts 800 includes receiving digital activity corresponding to the plurality of client devices indicating copying one or more content items. Moreover, in one or more embodiments the series of acts 800 includes receiving digital activity corresponding to the plurality of client devices indicating downloading one or more content items. Additionally, in one or more embodiments the series of acts 800 includes receiving digital activity corresponding to the plurality of client devices indicating viewing one or more content items. In one or more embodiments the series of acts 800 includes receiving digital activity corresponding to the plurality of client devices indicating sharing one or more content items. In one or more embodiments the series of acts 800 includes receiving digital activity corresponding to the plurality of client devices indicating creating a public link for one or more content items.

Further, in one or more embodiments the series of acts 800 includes mapping the first source-specific data structure of the first third-party source to the unified data structure by referencing a first specification that indicates a naming convention of the first source-specific data structure corresponds to a first unified naming convention of the unified data structure. Moreover, in one or more embodiments the series of acts 800 includes mapping the second source-specific data structure of the second third-party source to the unified data structure by referencing a second specification that indicates a naming convention of the second source-specific data structure corresponds to a second unified naming convention of the unified data structure. Additionally, in one or more embodiments the series of acts 800 includes receiving the request comprising a query relating to a first type of digital activity and a second type of digital activity for a first client device and a second client device of the plurality of client devices. In one or more embodiments the series of acts 800 includes identifying the subset of unified data items comprising the source-specific data items for the first type of digital activity and the second type of digital activity for the first client device and the second client device, wherein the first type of digital activity and the second type of digital activity for the first client device and the second client device are performed on both the first third-party source and the second third-party source.

Further, in one or more embodiments the series of acts 800 includes generating a policy to control digital activity of the plurality of client devices using the first third-party source and the second third-party source. Moreover, in one or more embodiments the series of acts 800 includes detecting that digital activity of a client device from the plurality of client devices violated the policy on the first third-party source by analyzing the plurality of unified data items from the plurality of client devices. Additionally, in one or more embodiments the series of acts 800 includes causing the first third-party source to enforce the policy by reversing the digital activity of the client device. In one or more embodiments the series of acts 800 includes sending a notification to the client device regarding the violation of the policy.

Further, in one or more embodiments the series of acts 800 includes receiving a query from an administrator device to determine resource usage of one or more third-party sources. Moreover, in one or more embodiments the series of acts 800 includes generating an interactive data analytics report based on the plurality of unified data items to determine resource usage of one or more third-party sources. Additionally, in one or more embodiments the series of acts 800 includes provide the interactive data analytics report to the administrator device.

Further, in one or more embodiments the series of acts 800 includes receiving a plurality of source-specific data items from a first third-party source and a second third-party source, the plurality of source-specific data items comprising data representing digital activity of a plurality of client devices using the first third-party source and the second third-party source. Moreover, in one or more embodiments the series of acts 800 includes generating, from the plurality of source-specific data items, a plurality of unified data items by utilizing a translation layer that maps to a unified data structure. Additionally, in one or more embodiments the series of acts 800 includes identifying, based on a request comprising a query relating to digital activities of a client device of the plurality of client devices interacting with the first third-party source and the second third-party source, a subset of unified data items from the plurality of unified data items by processing the request using the unified data structure, the subset of unified data items being based on source-specific data items from both the first third-party source and the second third-party source. In one or more embodiments the series of acts 800 includes providing the subset of unified data items to the administrator device.

Further, in one or more embodiments the series of acts 800 includes receiving digital activity corresponding to the plurality of client devices indicating at least one of copying, downloading, viewing, sharing, or creating a public link. Moreover, in one or more embodiments the series of acts 800 includes mapping a first source-specific data structure of the first third-party source to the unified data structure by referencing a first specification that indicates a naming convention of the first source-specific data structure corresponds to a first unified naming convention of the unified data structure. Additionally, in one or more embodiments the series of acts 800 includes mapping a second source-specific data structure of the second third-party source to the unified data structure by referencing a second specification that indicates a naming convention of the second source-specific data structure corresponds to a second unified naming convention of the unified data structure.

In one or more embodiments the series of acts 800 includes generating a policy to control digital activity of the plurality of client devices using the first third-party source and the second third-party source. Moreover, in one or more embodiments the series of acts 800 includes detecting that digital activity of a client device from the plurality of client devices violated the policy on the first third-party source by analyzing the plurality of unified data items from the plurality of client devices. Additionally, in one or more embodiments the series of acts 800 includes mapping a second source-specific data structure of the second third-party source to the unified data structure by referencing a second specification that indicates a naming convention of the second source-specific data structure corresponds to a second unified naming convention of the unified data structure.

In one or more embodiments the series of acts 800 includes causing the first third-party source to enforce the policy by reversing the digital activity of the client device. Moreover, in one or more embodiments the series of acts 800 includes sending a notification to the client device regarding the violation of the policy. Additionally, in one or more embodiments the series of acts 800 includes generating, utilizing a large language model, a summary of the subset of unified data items from both the first third-party source and the second third-party source. In one or more embodiments the series of acts 800 includes providing the summary of the subset of unified data items to the administrator device.

The components of the unified digital activity system 102 can include software, hardware, or both. For example, the components of the unified digital activity system 102 can include one or more instructions stored on a computer-readable storage medium and executable by processors of one or more computing devices. When executed by one or more processors, the computer-executable instructions of the unified digital activity system 102 can cause a computing device to perform the methods described herein. Alternatively, the components of the unified digital activity system 102 can comprise hardware, such as a special purpose processing device to perform a certain function or group of functions. Additionally or alternatively, the components of the unified digital activity system 102 can include a combination of computer-executable instructions and hardware.

Furthermore, the components of the unified digital activity system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the unified digital activity system 102 may be implemented as part of a stand-alone application on a personal computing device or a mobile device.

Embodiments of the present disclosure may comprise or utilize a special purpose or general-purpose computer including computer hardware, such as, for example, one or more processors and system memory, as discussed in greater detail below. Implementations within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, implementations of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some implementations, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Implementations of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates a block diagram of exemplary computing device 900 (e.g., the server(s) 104, the server(s) 114, and/or the administrator device 110) that may be configured to perform one or more of the processes described above. One will appreciate that server(s) 104 and/or the administrator device 110 may comprise one or more computing devices such as computing device 900. As shown by FIG. 9, computing device 900 can comprise processor 902, memory 904, storage device 906, I/O interface 908, and communication interface 910, which may be communicatively coupled by way of communication infrastructure 912. While an exemplary computing device 900 is shown in FIG. 9, the components illustrated in FIG. 9 are not intended to be limiting. Additional or alternative components may be used in other implementations. Furthermore, in certain implementations, computing device 900 can include fewer components than those shown in FIG. 9. Components of computing device 900 shown in FIG. 9 will now be described in additional detail.

In particular implementations, processor 902 includes hardware for executing instructions, such as those making up a computer program. As an example, and not by way of limitation, to execute instructions, processor 902 may retrieve (or fetch) the instructions from an internal register, an internal cache, memory 904, or storage device 906 and decode and execute them. In particular implementations, processor 902 may include one or more internal caches for data, instructions, or addresses. As an example, and not by way of limitation, processor 902 may include one or more instruction caches, one or more data caches, and one or more translation lookaside buffers (TLBs). Instructions in the instruction caches may be copies of instructions in memory 904 or storage device 906.

Memory 904 may be used for storing data, metadata, and programs for execution by the processor(s). Memory 904 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. Memory 904 may be internal or distributed memory.

Storage device 906 includes storage for storing data or instructions. As an example, and not by way of limitation, storage device 906 can comprise a non-transitory storage medium described above. Storage device 906 may include a hard disk drive (HDD), a floppy disk drive, flash memory, an optical disc, a magneto-optical disc, magnetic tape, or a Universal Serial Bus (USB) drive or a combination of two or more of these. Storage device 906 may include removable or non-removable (or fixed) media, where appropriate. Storage device 906 may be internal or external to computing device 900. In particular implementations, storage device 906 is non-volatile, solid-state memory. In other implementations, Storage device 906 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 908 allows a user to provide input to, receive output from, and otherwise transfer data to and receive data from computing device 900. I/O interface 908 may include a mouse, a keypad or a keyboard, a touch screen, a camera, an optical scanner, network interface, modem, other known I/O devices or a combination of such I/O interfaces. I/O interface 908 may include one or more devices for presenting output to a user, including, but not limited to, a graphics engine, a display (e.g., a display screen), one or more output drivers (e.g., display drivers), one or more audio speakers, and one or more audio drivers. In certain implementations, I/O interface 908 is configured to provide graphical data to a display for presentation to a user. The graphical data may be representative of one or more graphical user interfaces and/or any other graphical content as may serve a particular implementation.

Communication interface 910 can include hardware, software, or both. In any event, communication interface 910 can provide one or more interfaces for communication (such as, for example, packet-based communication) between computing device 900 and one or more other computing devices or networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 910 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 910 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 910 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 912 may include hardware, software, or both that couples components of computing device 900 to each other. As an example and not by way of limitation, communication infrastructure 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

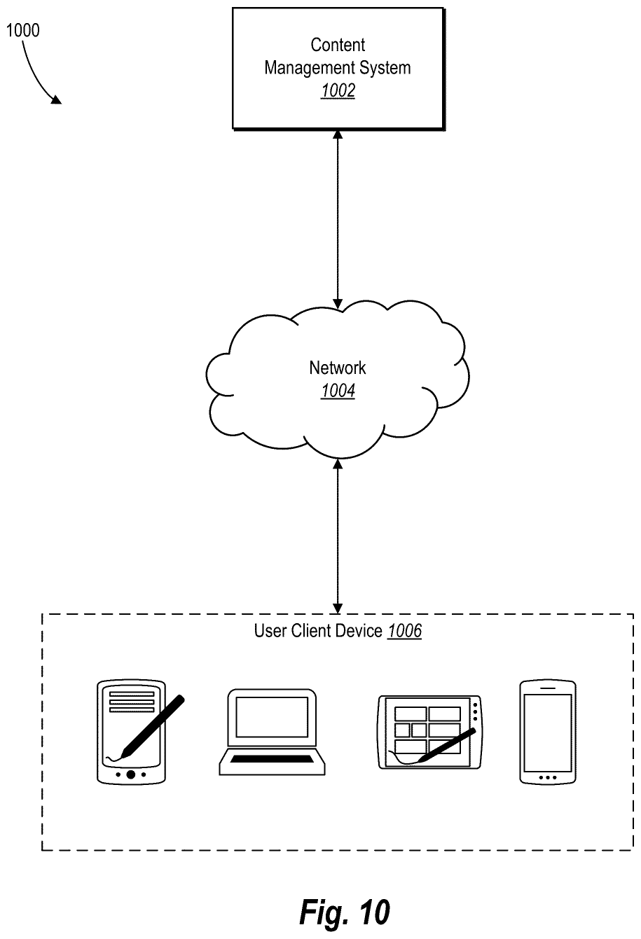

FIG. 10 is a schematic diagram illustrating environment 1000 within which one or more implementations of the unified digital activity system 102 can be implemented. For example, the unified digital activity system 102 may be part of a content management system 1002 (e.g., the content management system 106). Content management system 1002 may generate, store, manage, receive, and send digital content (such as digital content items). For example, content management system 1002 may send and receive digital content to and from client device of client devices 1006 by way of network 1004. In particular, content management system 1002 can store and manage a collection of digital content. Content management system 1002 can manage the sharing of digital content between computing devices associated with a plurality of users. For instance, content management system 1002 can facilitate a user sharing a digital content with another user of content management system 1002.

In particular, content management system 1002 can manage synchronizing digital content across multiple client devices 1006 associated with one or more users. For example, a user may edit digital content using a client device of the client device 1006. The content management system 1002 can cause client device of the client devices 1006 to send the edited digital content to content management system 1002. Content management system 1002 then synchronizes the edited digital content on one or more additional computing devices.

In addition to synchronizing digital content across multiple devices, one or more implementations of content management system 1002 can provide an efficient storage option for users that have large collections of digital content. For example, content management system 1002 can store a collection of digital content on content management system 1002, while the client device of the client devices 1006 only stores reduced-sized versions of the digital content. A user can navigate and browse the reduced-sized versions (e.g., a thumbnail of a digital image) of the digital content on client device of the client devices 1006. In particular, one way in which a user can experience digital content is to browse the reduced-sized versions of the digital content on client device of client devices 1006.

Another way in which a user can experience digital content is to select a reduced-size version of digital content to request the full- or high-resolution version of digital content from content management system 1002. In particular, upon a user selecting a reduced-sized version of digital content, client device of client devices 1006 sends a request to content management system 1002 requesting the digital content associated with the reduced-sized version of the digital content. Content management system 1002 can respond to the request by sending the digital content to client device of client devices 1006. Client device of client devices 1006, upon receiving the digital content, can then present the digital content to the user. In this way, a user can have access to large collections of digital content while minimizing the amount of resources used on client device of client devices 1006.

client device of client devices 1006 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. client device of client devices 1006 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 1004.

Network 1004 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client device of client devices 1006 may access content management system 1002.

In the foregoing specification, the present disclosure has been described with reference to specific exemplary implementations thereof. Various implementations and aspects of the present disclosure(s) are described with reference to details discussed herein, and the accompanying drawings illustrate the various implementations. The description above and drawings are illustrative of the disclosure and are not to be construed as limiting the disclosure. Numerous specific details are described to provide a thorough understanding of various implementations of the present disclosure.

The present disclosure may be embodied in other specific forms without departing from its spirit or essential characteristics. The described implementations are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

The foregoing specification is described with reference to specific exemplary implementations thereof. Various implementations and aspects of the disclosure are described with reference to details discussed herein, and the accompanying drawings illustrate the various implementations. The description above and drawings are illustrative and are not to be construed as limiting. Numerous specific details are described to provide a thorough understanding of various implementations.

The additional or alternative implementations may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed:

1. A computer-implemented method comprising:
receiving a plurality of source-specific data items from a first third-party source and a second third-party source, the plurality of source-specific data items comprising data representing digital activity of a plurality of client devices using the first third-party source and the second third-party source;
generating, from the plurality of source-specific data items, a plurality of unified data items by utilizing a translation layer that maps source-specific data structures to a unified data structure;
identifying, based on a request from an administrator device, a subset of unified data items from the plurality of unified data items by processing the request using the unified data structure, the subset of unified data items being based on source-specific data items from both the first third-party source and the second third-party source; and
providing the subset of unified data items to the administrator device.

2. The computer-implemented method of claim 1, wherein the plurality of source-specific data items comprises an indication of digital activity corresponding to the plurality of client devices comprising at least one of copying, downloading, viewing, sharing, or creating a public link.

3. The computer-implemented method of claim 1, wherein utilizing the translation layer that maps the source-specific data structures to the unified data structure comprises:
mapping a first source-specific data structure of the first third-party source to the unified data structure by referencing a first specification that indicates a naming convention of the first source-specific data structure corresponds to a first unified naming convention of the unified data structure; and
mapping a second source-specific data structure of the second third-party source to the unified data structure by referencing a second specification that indicates a naming convention of the second source-specific data structure corresponds to a second unified naming convention of the unified data structure.

4. The computer-implemented method of claim 1, wherein identifying the subset of unified data items comprises:
receiving the request comprising a query relating to a first type of digital activity and a second type of digital activity for a first client device of the plurality of client devices; and
identifying the subset of unified data items comprising the source-specific data items for the first type of digital activity and the second type of digital activity for the first client device, wherein the first type of digital activity and the second type of digital activity for the first client device are performed on both the first third-party source and the second third-party source.

5. The computer-implemented method of claim 1, further comprising:
generating a policy to control digital activity of the plurality of client devices using the first third-party source and the second third-party source;
detecting that digital activity of a client device from the plurality of client devices violated the policy on the first third-party source by analyzing the plurality of unified data items from the plurality of client devices;
causing the first third-party source to enforce the policy by reversing the digital activity of the client device; and
sending a notification to the client device regarding the violation of the policy.

6. The computer-implemented method of claim 1, further comprising:
generating a policy to control digital activity of the plurality of client devices using the first third-party source and the second third-party source;
detecting a violation of the policy by a client device of the plurality of client devices; and
sending a notification to the administrator device to provide an exception to the policy for the client device.

7. The computer-implemented method of claim 1, further comprising:
generating a policy to control digital activity of the plurality of client devices using the first third-party source and the second third-party source;
establishing a threshold monitoring policy for the policy;
detecting a plurality of violations of the policy that satisfies the threshold monitoring policy by monitoring the plurality of unified data items; and
in response to detecting the plurality of violations, sending a notification to the administrator device regarding the plurality of violations.

8. The computer-implemented method of claim 1, wherein providing the subset of unified data items to the administrator device further comprises:
generating, utilizing a large language model, a summary of the subset of unified data items from both the first third-party source and the second third-party source; and
providing the summary of the subset of unified data items to the administrator device.

9. The computer-implemented method of claim 1, further comprising:
monitoring the plurality of unified data items from the plurality of client devices to determine that a client device accessed a third third-party source;
comparing the third third-party source to a database of approved third-party sources; and
in response to determining that the third third-party source is not an approved third-party source, sending a notification to the administrator device.

10. A system comprising:
at least one processor; and
a non-transitory computer-readable medium storing instructions which, when executed by the at least one processor, cause the system to:
receive a plurality of source-specific data items from a first third-party source and a second third-party source, the plurality of source-specific data items comprising data representing digital activity of a plurality of client devices using the first third-party source and the second third-party source;
generate, from the plurality of source-specific data items, a plurality of unified data items by utilizing a translation layer that maps a first source-specific data structure of the first third-party source and a second source-specific data structure of the second third-party source to a unified data structure;
identify, based on a request from an administrator device, a subset of unified data items from the plurality of unified data items by processing the request using the unified data structure, the subset of unified data items being based on source-specific data items from both the first third-party source and the second third-party source; and
provide the subset of unified data items to the administrator device.

11. The system of claim 10, wherein receiving the plurality of source-specific data items comprises:
receiving digital activity corresponding to the plurality of client devices indicating copying one or more content items;
receiving digital activity corresponding to the plurality of client devices indicating downloading one or more content items;
receiving digital activity corresponding to the plurality of client devices indicating viewing one or more content items;
receiving digital activity corresponding to the plurality of client devices indicating sharing one or more content items; or
receiving digital activity corresponding to the plurality of client devices indicating creating a public link for one or more content items.

12. The system of claim 10, further storing instructions which, when executed by the at least one processor, cause the system to utilize the translation layer that maps the first source-specific data structure and the second source-specific data structure to the unified data structure by:
mapping the first source-specific data structure of the first third-party source to the unified data structure by referencing a first specification that indicates a naming convention of the first source-specific data structure corresponds to a first unified naming convention of the unified data structure; and
mapping the second source-specific data structure of the second third-party source to the unified data structure by referencing a second specification that indicates a naming convention of the second source-specific data structure corresponds to a second unified naming convention of the unified data structure.

13. The system of claim 10, further storing instructions, which when executed by the at least one processor cause the system to identify the subset of unified data items by:
receiving the request comprising a query relating to a first type of digital activity and a second type of digital activity for a first client device and a second client device of the plurality of client devices; and
identifying the subset of unified data items comprising the source-specific data items for the first type of digital activity and the second type of digital activity for the first client device and the second client device, wherein the first type of digital activity and the second type of digital activity for the first client device and the second client device are performed on both the first third-party source and the second third-party source.

14. The system of claim 10, further storing instructions, which when executed by the at least one processor cause the system to:
generate a policy to control digital activity of the plurality of client devices using the first third-party source and the second third-party source;
detect that digital activity of a client device from the plurality of client devices violated the policy on the first third-party source by analyzing the plurality of unified data items from the plurality of client devices;
cause the first third-party source to enforce the policy by reversing the digital activity of the client device; and
send a notification to the client device regarding the violation of the policy.

15. The system of claim 10, further storing instructions, which when executed by the at least one processor cause the system to:
receive a query from an administrator device to determine resource usage of one or more third-party sources;
generate an interactive data analytics report based on the plurality of unified data items to determine resource usage of one or more third-party sources; and
provide the interactive data analytics report to the administrator device.

16. A non-transitory computer-readable medium storing executable instructions which, when executed by at least one processor, cause the at least one processor to:
receive a plurality of source-specific data items from a first third-party source and a second third-party source, the plurality of source-specific data items comprising data representing digital activity of a plurality of client devices using the first third-party source and the second third-party source;
generate, from the plurality of source-specific data items, a plurality of unified data items by utilizing a translation layer that maps to a unified data structure;
identify, based on a request comprising a query relating to digital activities of a client device of the plurality of client devices interacting with the first third-party source and the second third-party source, a subset of unified data items from the plurality of unified data items by processing the request using the unified data structure, the subset of unified data items being based on source-specific data items from both the first third-party source and the second third-party source; and
provide the subset of unified data items to an administrator device.

17. The non-transitory computer-readable medium of claim 16, further storing instructions which, when executed by the at least one processor, cause the at least one processor to receive digital activity corresponding to the plurality of client devices indicating at least one of copying, downloading, viewing, sharing, or creating a public link.

18. The non-transitory computer-readable medium of claim 16, further storing instructions which, when executed by the at least one processor, cause the at least one processor to utilizing the translation layer that maps source-specific data structures to the unified data structure by:
mapping a first source-specific data structure of the first third-party source to the unified data structure by referencing a first specification that indicates a naming convention of the first source-specific data structure corresponds to a first unified naming convention of the unified data structure; and
mapping a second source-specific data structure of the second third-party source to the unified data structure by referencing a second specification that indicates a naming convention of the second source-specific data structure corresponds to a second unified naming convention of the unified data structure.

19. The non-transitory computer-readable medium of claim 16, further storing instructions which, when executed by the at least one processor, cause the at least one processor to:
generate a policy to control digital activity of the plurality of client devices using the first third-party source and the second third-party source;
detect that digital activity of a client device from the plurality of client devices violated the policy on the first third-party source by analyzing the plurality of unified data items from the plurality of client devices;
cause the first third-party source to enforce the policy by reversing the digital activity of the client device; and
send a notification to the client device regarding the violation of the policy.

20. The non-transitory computer-readable medium of claim 16, further storing instructions which, when executed by the at least one processor, cause the at least one processor to:
generate, utilizing a large language model, a summary of the subset of unified data items from both the first third-party source and the second third-party source; and
provide the summary of the subset of unified data items to the administrator device.
